(19) United States
(12) Patent Application Publication
(10) Pub. No.: US 2018/0073889 A1
(43) Pub. Date: Mar. 15, 2018

(54) METHODS AND SYSTEMS FOE ELECTRONIC DEVICE INTERACTIONS

(71) Applicant: SNAPBACK S.r.l., Rome (IT)

(72) Inventors: Ester VIGILANTE, Rome (IT); Claudio CAPOBIANCPO, Rome (IT); Gerardo GORGÅ, Vietri di Potenza (IT); Marco MEZZA VILLA, Castelfranco Veneto (IT); Giusepp MORLINO, Potenza (IT)

(21) Appl. No.: 15/563,628

(22) PCT Filed: Mar. 31, 2016
(86) PCT No.: PCT/IL2016/050349

§ 371 Date: Oct. 2, 2017

Related U.S. Application Data
(60) Provisional application No. 62/141,275, filed on Apr. 1, 2015.

(51) Int. Cl. G01C 21/36; H04W 4/18; H04W 4/04; G01C 21/20; G06F 3/0481; G06F 3/01

(52) U.S. Cl. CPC G01C 21/3679; H04W 4/185; G06F 3/011; G01C 21/20; G06F 3/0481; H04W 4/04

(57) ABSTRACT

Methods and systems provide for interactions by one or more mobile computing devices, for example, smartphones (cellular and network linked), smart bands, smart watches, augmented and virtual reality headsets, which alone or in combination form mobile computing device systems, through localization, mapping of points of interest (PoIs), pointing, selection, engagement and control of controllable electronic devices.

### CROSS REFERENCES TO RELATED APPLICATIONS

This application is related to and claims priority from commonly owned U.S. Provisional Patent Application Ser. No. 62/141,275, entitled: Methods and Systems for Electronic Device Interactions, filed on Apr. 1, 2015, the disclosure of which is incorporated by reference in its entirety herein.

### TECHNICAL FIELD

The present invention is directed to interactions between mobile computing devices and objects, including controlling electronic devices from the mobile computing devices.

### BACKGROUND OF THE INVENTION

Conventional interactions between electronic devices and controllers are conventionally performed by dedicated remote controllers. The methods of use for these remote controllers are suitable, provided that the number of electronic devices to be controlled is limited, such as to a single television. As a result, most rooms include multiple remote controls for each specific electronic device. This situation only becomes worse as additional electronic devices are added to the room, as well as the arrival of new paradigms, such as Internet of Things, connected-homes or connected-offices.

To solve some of these problems, “universal” remote controllers have been developed. Universal controllers are a single remote control from which multiple electronic devices are controlled. However, universal remote controllers exhibit drawbacks in that they are often difficult to configure and it is difficult to select the device which is to be controlled at any particular instant.

### SUMMARY OF THE INVENTION

The present invention provides a reliable and coherent solution for different contexts and operative environments.

The present invention discloses methods and systems for interactions by one or more mobile computing devices, for example, smartphones (cellular and network linked), smart bands, smart watches, augmented and virtual reality headsets, which alone or in combination form mobile computing device systems, through localization, mapping of points of interest (PoIs), pointing, selection, engagement and control of controllable electronic devices. Mapping of points of interest is performed based on the user's and the electronic device's current location. The interactions of the mobile computing device(s) may be via touchable or non-touchable (touchless) controls, such as voice, sound, motion, or gestures commands. The communication between the mobile computing device system/device(s) and the controlled devices, for example, televisions, appliances, lights, may be via direct links or mediated by a network.

Embodiments of the present invention are directed to a method for providing mobile computing device system interactions. The method comprises: populating an electronic map with at least one point of interest; receiving 1) location data, and 2) pointing data corresponding to the at least one point of interest, from the mobile computing device system; for the location corresponding to the received location data, correlating the location associated with the received pointing data with the location and orientation of the at least one point of interest; and, causing an action to be taken associated with the at least one point of interest.

Optionally, the populated electronic map is stored in storage media.

Optionally, the action to be taken includes controlling an electronic device, by the mobile computing device system.

Optionally, the electronic device and the at least one point of interest are the same.

Optionally, the electronic device and the at least one point of interest are different.

Optionally, the action be taken includes obtaining data for the mobile computing device system.

Optionally, the mobile computing device system includes a smartphone.

Optionally, the mobile computing device system includes a smartphone in communication with a wearable or sub-dermal computing device, and the pointing data is obtained from the wearable or sub-dermal computing device.

Optionally, the method is performed by at least one processor of a computer system.

Optionally, the computer system resides on a server linked to a network, and the mobile computing device system is linked to the network.

Optionally, the computer system resides on the mobile computing device system.

Optionally, the computer system resides in both of a server and the mobile computing device system, and, the server and the mobile computing device system are linked to each other by a network.

Optionally, populating the electronic map includes: designating a location for the map; providing the map with electronic coordinates; and, inputting at least one point of interest to the map, the at least one point of interest including electronic coordinates within the map.

Optionally, the inputting at least one point of interest includes converting pointing data received from the mobile computing device system to coordinates on the map.

Optionally, populating the electronic map includes: obtaining an electronic map with electronic coordinates associated with a location; and, inputting the at least one point of interest to the map, by converting pointing data received from the mobile computing device system to coordinates on the map.

Optionally, the correlating includes determining that the location associated with the received pointing data and the location of the at least one point of interest, are within a predetermined distance from each other.

Other embodiments of the invention are directed to a method for operating a mobile computing device system. The method comprises: receiving, by a computing system, an electronic map of a predetermined location populated with at least one point of interest within the predetermined location; receiving, by the computing system: 1) location data of the predetermined location; and, 2) pointing data corresponding to the at least one point of interest within the predetermined location, from the mobile computing device system; for the predetermined location corresponding to the received location data, the computing system, correlating the location associated with the received pointing data with the location of the at least one point of interest; and, causing, by the computing system, an action to be taken associated with the at least one point of interest.

Optionally, the computing system resides on a mobile computing device system.

Optionally,the mobile computing device system includes at least one mobile computing device.

Optionally, the mobile computing device system includes at least two mobile computing devices comprising: a smartphone in communication with a wearable or sub-dermal computing device.

Optionally, the computing system resides on a server, the server linked to the mobile computing device system by a network.

Optionally, the computing system resides on a server, the server linked to the mobile computing device system by a network.

Optionally, the computing system resides in part on both the on server and the mobile computing system.

Optionally, the correlating includes determining that the location associated with the received pointing data and the location of the at least one point of interest, are within a predetermined distance from each other.

Embodiments of the present invention are directed to a method for operating a mobile computing device system. The method comprises: associating location data of the mobile computing device system with an electronic map, the electronic map including at least one point of interest; and, signaling the mobile computing device system when the pointing direction of the mobile computing system correlates with the at least one point of interest.

Optionally, the signaling is such that the mobile computing system provides at least one of a visual, tactile or audio indication upon the correlation of the mobile computing system with the at least one point of interest.

Optionally, the mobile computing system includes a pointing device and a signaling device.

Optionally, the pointing device and the signaling device are selected from the group consisting of smart phones, smart bands, smart watches, sub-dermal microchip implant, augmented and virtual reality headsets.

Optionally, the mobile computing system includes a single mobile computing device.

Embodiments of the invention are directed to a computerized system for facilitating mobile computing device system interactions. The system comprises: a mapping system for creating electronic maps of at least one point of interest; a pointing system for determining whether a mobile computing device of the mobile computing device system is directed to the at least one point of interest; a localization system for determining the location associated with the mobile computing device; and, an engagement system for engaging the mobile computing device system with the at least one point of interest, the engaging causing the mobile computing device system to perform an action associated with the at least one point of interest.

Optionally, the action associated with the at least one point of interest includes receiving, by the mobile computing device system, at least one of feedback associated with the at least one point of interest, and data corresponding to information associated with the at least one point of interest.

Optionally, the engagement system is configured for determining a correlation between the location of the mobile computing device and the location of the at least one point of interest based on a predetermined distance between the locations. Optionally, the computerized system additionally comprises a point of interest database linked to the mapping system.

Optionally, the computerized system additionally comprises a control system for controlling at least one electronic device associated with the at least one point of interest.

Optionally, the computerized system additionally comprises a selection system for selecting one point of interest when the at least one point of interest includes at least two points of interest.

Optionally, the computerized system additionally comprises a network communication system for facilitating communications between the computerized system and components over a network.

Optionally, the computerized system resides on a mobile computing device system.

Optionally, the mobile computing device system includes at least one of a smartphone and an augmented or virtual reality headset.

Optionally, the mobile computing device system includes a smartphone or augmented or virtual reality headset in communication with a wearable or sub-dermal computing device.

Embodiments of the invention are directed to a computer-usable non-transitory storage medium having a computer program embodied thereon for causing a suitable programmed system to provide mobile computing device system interactions, by performing the following steps when such program is executed on the system. The steps comprise: populating an electronic map with at least one point of interest; receiving 1) location data, and 2) pointing data corresponding to the at least one point of interest, from the mobile computing device system; for the location corresponding to the received location data, correlating the location associated with the received pointing data with the location of the at least one point of interest; and, causing an action to be taken associated with the at least one point of interest.

Embodiments of the invention are directed to a computer-usable non-transitory storage medium having a computer program embodied thereon for causing a suitable programmed system to facilitate mobile computing device system interactions, by performing the following steps when such program is executed on the system. The steps comprise: receiving an electronic map of a predetermined location populated with at least one point of interest within the predetermined location; receiving: 1) location data of the predetermined location; and, 2) pointing data corresponding to the at least one point of interest within the predetermined location, from the mobile computing device system; for the predetermined location corresponding to the received location data, correlating the location associated with the received pointing data with the location of the at least one point of interest; and, causing an action to be taken associated with the at least one point of interest.

Embodiments of the present invention are directed to a method for controlling electronic devices. The method comprises: locating a controlling device in an electronically mapped space; responding to the locating of the controlling device by placing the controlling device in the electronically mapped space in electronic communication with the electronic device to be controlled; and, performing an action associated with the controlling device to control the electronic device.

Optionally, the mapped space is based on a static electronic map.

Optionally, the mapped space is based on a dynamically created electronic map.

This document references terms that are used consistently or interchangeably herein. These terms, including variations thereof, are as follows.

A “computer” includes machines, computers, and computing or computer systems (for example, physically separate locations or devices), servers, computer, computing, and computerized devices, processors, processing systems, computing cores (for example, shared devices), and similar systems, workstations, modules and combinations of the aforementioned. The aforementioned “computer” may be in various types, such as a personal computer (e.g., laptop, desktop, tablet computer), or any type of computing device, including mobile computing devices that can be readily transported from one location to another location, for example, smartphones (cellular and network linked), smart bands, smart watches, augmented and virtual reality headsets, personal digital assistants (PDA).

A server is typically a remote computer or remote computer system, or computer program therein, in accordance with the “computer” defined above, that is accessible over a communications medium, such as a communications network or other computer network, including the Internet. A “server” provides services to, or performs functions for, other computer programs (and their users), in the same or other computers. A server may also include a virtual machine, a software based emulation of a computer.

An “application”, includes executable software, and optionally, any graphical user interfaces (GUI), through which certain functionality may be implemented.

A “client” is an application that runs on a computer, workstation or the like and relies on a server to perform some of its operations or functionality.

“n” and “nth” refer to the last member of a varying or potentially infinite series.

Unless otherwise defined herein, all technical and/or scientific terms used herein have the same meaning as commonly understood by one of ordinary skill in the art to which the invention pertains. Although methods and materials similar or equivalent to those described herein may be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF DRAWINGS

Some embodiments of the present invention are herein described, by way of example only, with reference to the accompanying drawings. With specific reference to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

Attention is now directed to the drawings, where like reference numerals or characters indicate corresponding or like components. In the drawings:

FIGS. 1A-1F are diagrams of example environments in which embodiments of the invention are performed:

FIG. 2A is an illustration of a successful engagement of a two-dimensional (2D) point of interest (PoI) in accordance with embodiments of the present invention;

FIG. 2B is an illustration of an unsuccessful engagement of a two-dimensional (2D) point of interest (PoI) in accordance with embodiments of the present invention;

FIG. 2C is an illustration of another unsuccessful engagement of a two-dimensional (2D) point of interest (PoI) in accordance with embodiments of the present invention;

FIG. 2D is an illustration of a successful engagement of a two-dimensional (2D) point of interest (PoI), without orientation, in accordance with embodiments of the present invention;

FIG. 3 is an illustration of a successful engagement of three-dimensional (3D) point of interest (PoI) in accordance with embodiments of the present invention;

FIG. 4 is a block diagram of the overall architecture of a system in accordance with embodiments of the present invention;

FIG. 5 is a block diagram of a system of the present invention as used in the embodiment of FIG. 1A;

FIG. 6 is a block diagram of a system of the present invention as used in the embodiment of FIG. 1B;

FIG. 7 is a block diagram of a system of the present invention as used in the embodiment of FIG. 1C;

FIG. 8 is a block diagram of a system of the present invention as used in the embodiment of FIG. 1D;

FIG. 9 is a block diagram of a system of the present invention as used in the embodiment of FIG. 1E;

FIG. 10 is a block diagram of a system of the present invention as used in the embodiment of FIG. 1F;

FIGS. 11A-1, 11A-2, 11A-3, 11B and 11C are flow diagrams showing processes (methods) in accordance with embodiments of the present invention;

FIG. 12 is a flow diagram of a process (method) for updating a PoI database;

FIG. 13 is a flow diagram of a process (method) for control operations;

FIG. 14 is a flow diagram of a process (method) for engaging, selecting and disengaging a PoI, which is the process of block 1322 of FIG. 13 in detail;

FIG. 15 is a flow diagram of a process (method) for an engagement condition check of a PoI;

FIGS. 16A and 16B are diagrams of systems responsive to feedback, in accordance with embodiments of the present invention;

FIG. 16C is an illustration of several waypoints coordinated to create a path towards a destination PoI, in accordance with embodiments of the present invention;

FIG. 16D is a flow diagram of a the underlying process associated with the embodiments of FIGS. 16A-16C;

FIGS. 17A-1 to 17A-3 are diagrams of another embodiment of the present invention;

FIG. 17B is an illustration of user receiving information about a PoI directly from the PoI itself, in accordance with the present invention;

FIGS. 18A and 18B are illustrations of a user adding new PoIs into the PoI database, in accordance with embodiments of the present invention;

FIG. 19 is a picture of a user pointing towards a PoI using a smartband, in accordance with embodiments of the present invention;

FIG. 20 is a picture of a user receiving feedback on his smart band by pointing towards a PoI, in accordance with embodiments of the present invention;

FIG. 21A is a picture of a user creating a new PoI by pointing towards a wall, in accordance with embodiments of the present invention;

FIG. 21B is a picture of the same user of FIG. 21A, adding an audio content (e.g., voice message) to the newly created PoI; and,

FIG. 22 is an illustration of a user receiving feedback by pointing a smart wearable linked to a augmented or virtual reality headset, towards a PoI, in accordance with embodiments of the present invention.

### DETAILED DESCRIPTION OF DRAWINGS

Before explaining at least one embodiment of the invention in detail, it is to be understood that the invention is not necessarily limited in its application to the details of construction and the arrangement of the components and/or methods set forth in the following description and/or illustrated in the drawings. The invention is capable of other embodiments or of being practiced or carried out in various ways.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more non-transitory computer readable (storage) medium(s) having computer readable program code embodied thereon.

Throughout this document, numerous textual and graphical references are made to trademarks, and domain names. These trademarks and domain names are the property of their respective owners, and are referenced only for explanation purposes herein.

The present invention is directed to interactions of one or more electronic devices, including communication devices, these electronic and communication devices such as mobile computing device systems (formed of mobile computing devices), with electronically mapped objects, e.g., Points of Interest (PoIs), whose spatial coordinates indicative of their position and location are stored in computer databases. These interactions result in the actions by the mobile computing device system, such as the mobile computing device system receiving data and or feedback associated with the objects or electronically controlling a controllable electronic device, such as a television, appliance, lighting, moveable doors, and the like. The mobile computing device systems include, mobile computing devices, for example, smartphones, either alone or in communication with, or otherwise linked to smart bands, smart watches, and other smart wearables, and subdermal computing devices, including microchips, and, augmented and virtual reality headsets, either alone or linked with smart bands, smart watches, and other smart wearables, and subdermal computing devices, including microchips.

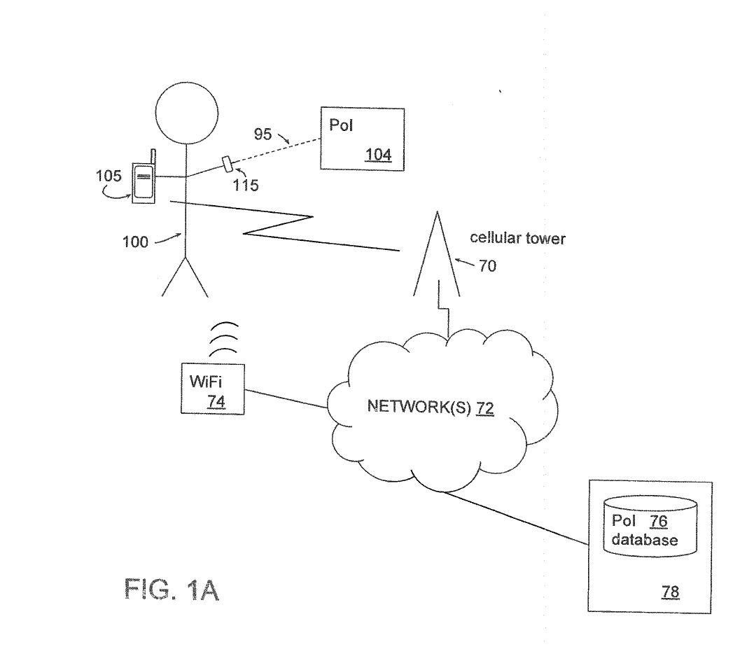

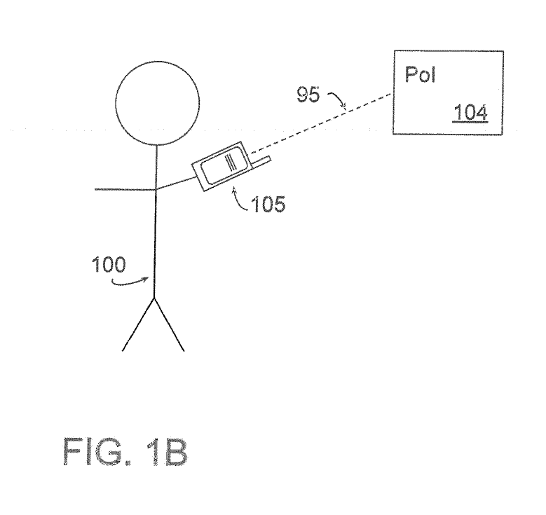

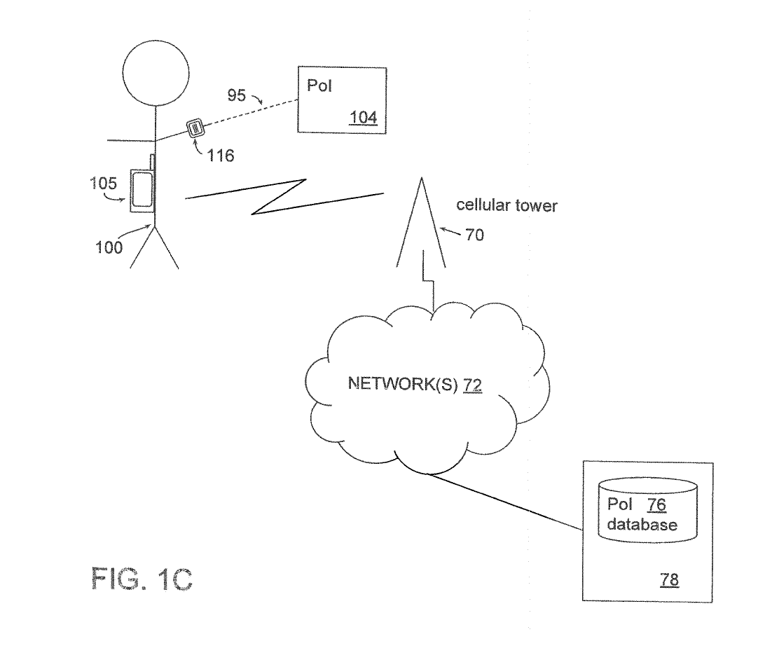

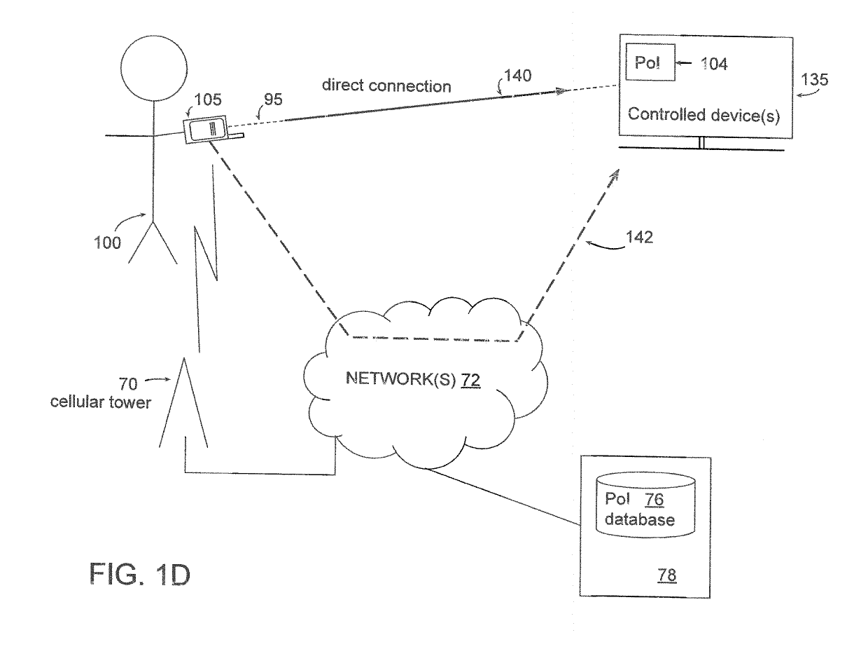

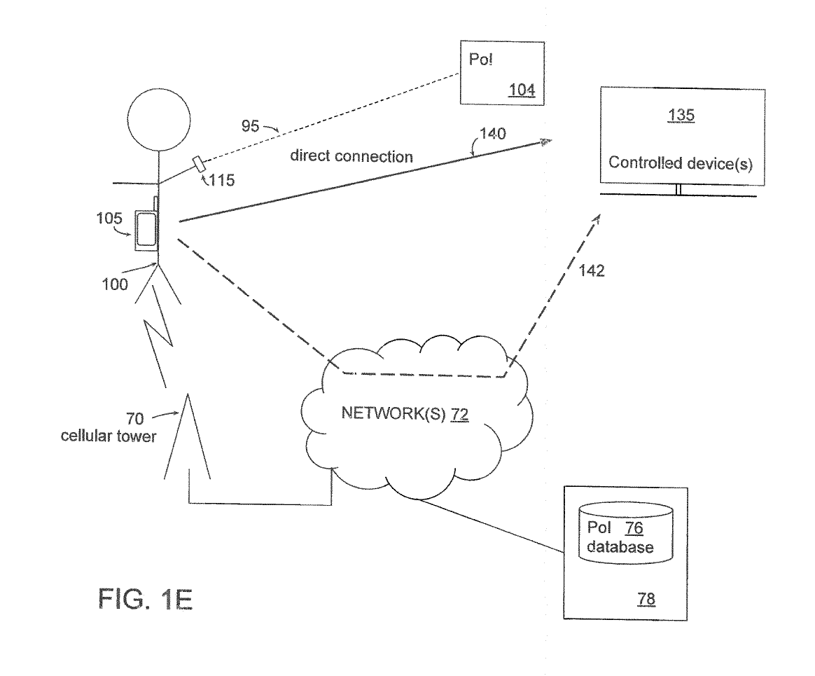

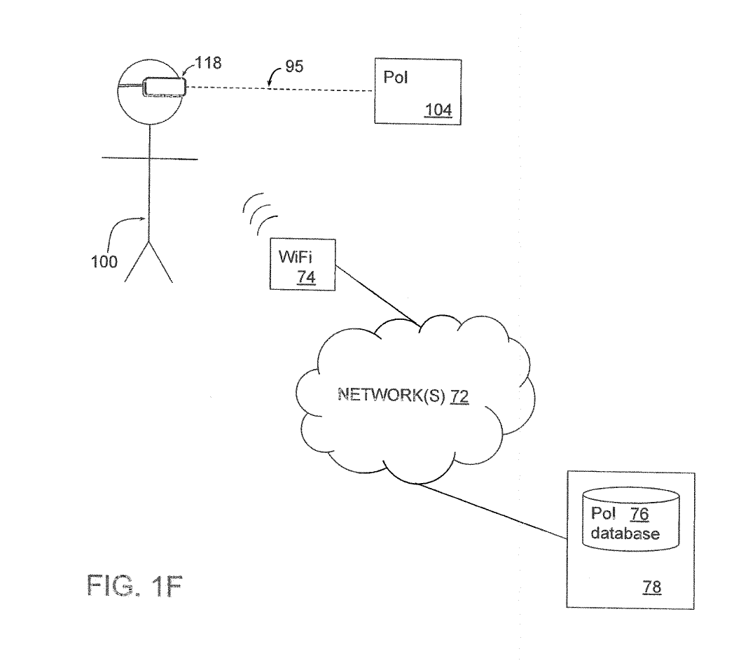

FIGS. 1A-1F illustrate various exemplary embodiments of the present invention.

FIG. 1A is an illustration of embodiment in which the user 100 uses mobile computing device system, including, for example, a smartphone 105 linked to a wearable computerized device, such as a wrist band or smart band 115, by wireless links such as Bluetooth®. The smartphone 105 is, for example, for localization, control, network communication and feedback, and the smart band 115 operates as a pointing device. There is a Point of Interest (PoI) database 76 hosted by a remote server 78, linked to a network 72.

The network 72 is, for example, a communications network, such as a Local Area Network (LAN), or a Wide Area Network (WAN), including public networks such as the Internet. The network 72 is either a single network or a combination of networks and/or multiple networks, including also (in addition to the aforementioned communications networks such as the Internet), for example, cellular networks. “Linked” as used herein includes both wired or wireless links, either direct or indirect, and placing the computers, including, servers, computer and computerized devices, components and the like, in electronic and/or data communications with each other.

The PoI database 76 provides mapped coordinates for a location of known coordinates, the coordinates established by a Global Positioning System (GPS) or other geolocation system. The location of the smartphone 105 is known Global Positioning System (GPS) or other geolocation systems, including triangulation, and indoor positioning systems using Bluetooth® beacons. Accordingly, the location of the smart band 115 is also known with respect to the location of the smartphone.

In this figure, a user 100 (e.g. a person) is receiving information about a point of interest (PoI) 104, such as an object, on his own portable smart-device 105 (e.g. a smartphone) by pointing his wrist-worn device 115 (e.g. a smart-band) in the direction 95 of the PoI 104. In this document, a point of Interest (PoI) 104 is an abstract entity that has a position in space and optionally orientation. Points of Interest (PoIs) may be physically located within and/or associated with an electronic device, such as mobile computing devices (e.g., smart phones, smart bands, smart watches, and other smart wearables, and subdermal computing devices, including microchips, and, augmented and virtual reality headsets) of the mobile computing device systems, as disclosed herein, as well as controllable electronic devices, which are controlled by the aforementioned mobile computing devices of the mobile computing device systems. The PoI 104, is, for example, a city bus, and user receives information about routes of specific buses. PoI 104 locations and associated content are obtained from the remote server 78, which includes the database of all PoIs 76 within a mapped coordinate space or mapped location, so as to form an electronic map of the location of the PoI 104. Here, for example, the database 76 is updated in real-time, with the position of the busses as they moving through the city. The remote server 78 is accessible through the network 72. The device, e.g., smartphone, 105 and the network 72 communicate through a Wi-Fi access point 74, a cellular tower 70, or other on-line connection.

The smartphone 105 is programmed to determine whether these is a correlation between the location of the smartphone 105 and the location of the PoI 104, as received from the PoI database 76. Should the locations correlate, the user 100, will receive information about the bus, its travel times, routes, and other information, associated with the bus. A correlation, for example, occurs when the aforementioned location are the same or proximate to each other, such as within a predetermined or preprogrammed distance from each other. In this example, the PoI 104 is a public bus or other transport vehicle, and the detected location of the mobile computing system pointing to this bus, which is mapped in the PoI database 76. With a correlation of the aforementioned locations, the user 100, will receive information about the bus, its travel times, routes, and other information, associated with the bus.

The embodiments of FIGS. 1B-1F are similar to the embodiment of the invention shown in FIG. 1A, with the differences noted.

FIG. 1B is similar to that of FIG. 1A, and shows a user 100 (e.g., a person), who is receiving information on his own portable computerized device 105 (e.g., a smartphone) about waiting times of public buses, by pointing the device 105 in the direction 95 of a PoI 104, which is, for example, a bus stop pole. In this example, the PoI database 76 is located in the portable device 105. Should the locations of the smartphone 105 and the PoI 104 be the same or proximate to each other, as determined by the processor and system of the mobile computing device 105 (which is the mobile computing device system in this example) the user 100, will receive a list of bus departures, bus waiting times, and other information, associated with the busses that service this bus stop.

FIG. 1C a user 100 (e.g., a tourist) is receiving information on his own wrist-worn device 116 (e.g. a smart-watch) linked to a portable device 105 (e.g., a smartphone) (the wrist-worn device 116 and smartphone 105 defining a mobile computing device system) about a PoI 104 (e.g., a monument in sight to him), by pointing the wrist-worn device 116 in the direction 95 of the PoI 104. The user has his portable device 105 in his pocket that provides connectivity towards the network 72 and outdoor localization. In this example, the PoI database 76 in the remote server 78 is static (i.e., not dynamically updated). Should the locations of the wrist-worn device 116, via the smartphone 105 location, and the PoI 104 be the same or proximate to each other, as determined by the processor and system of the mobile computing device 105, the user 100, will receive information on his smartphone 105 and/or wrist-worn device 116, about the PoI 104, i.e., the monument to which the wrist-worn device 116 is being pointed toward.

In FIG. 1D, a user 100 (e.g., a person) is using his own portable device 105 in order to control a remote device 135 (e.g., a Smart television (TV)). In this example, the PoI 104 associated with the control of the remote device 135 is spatially located in the same location of the remote device itself, as mapped in the PoI database 76. The user 100 can engage the control of the remote device 135 by pointing the portable device 105 in the direction 95 of the remote device 135. The communication between user portable device 105, which serves as the mobile computing device system, and remote device 135, for example, is a direct connection 140 (e.g., Bluetooth®, WiFi® direct) or a connection 142 mediated by a network 72. Controls may include gesture to switch channel, change volume, pause and resume a movie and the like.

In FIG. 1E, a user 100, for example, is visiting a museum, and seeks to control a remote device 135 (e.g., a display screen) by pointing a wrist-worn device 115 in the direction of a PoI 104 (e.g., painting). In this example, the PoI 104 and the associated remote device 135 are not located in the same physical location. However, the PoI 104, e.g., the painting, and the remote device 135, along with their linkage, are mapped in the PoI database 76. The user 100 has a portable device 105 (for example, in his pocket), that provides network 72 connectivity and localization (e.g., indoor localization of the museum).

In FIG. 1F, a user 100, such as a tourist (e.g., a tourist) receives information about a PoI 104 (e.g., a monument) by pointing a head-worn device 118 (e.g., an augmented or virtual reality headset, defining a mobile computing device system) in the direction 95 of the PoI. The device 118 provides also localization and network connectivity. Should the locations of the head-worn device 118, and the monument be the same or proximate to each other (e.g., correlated to each other), as determined by the processor and system of the head-worn device 118, the user 100, will receive information on the head-worn device 118 about the PoI 104, i.e., the monument.

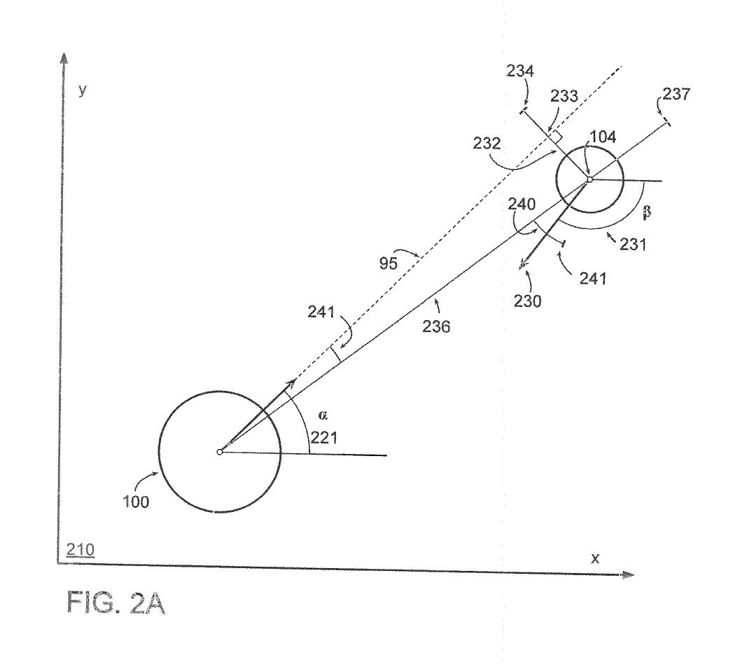

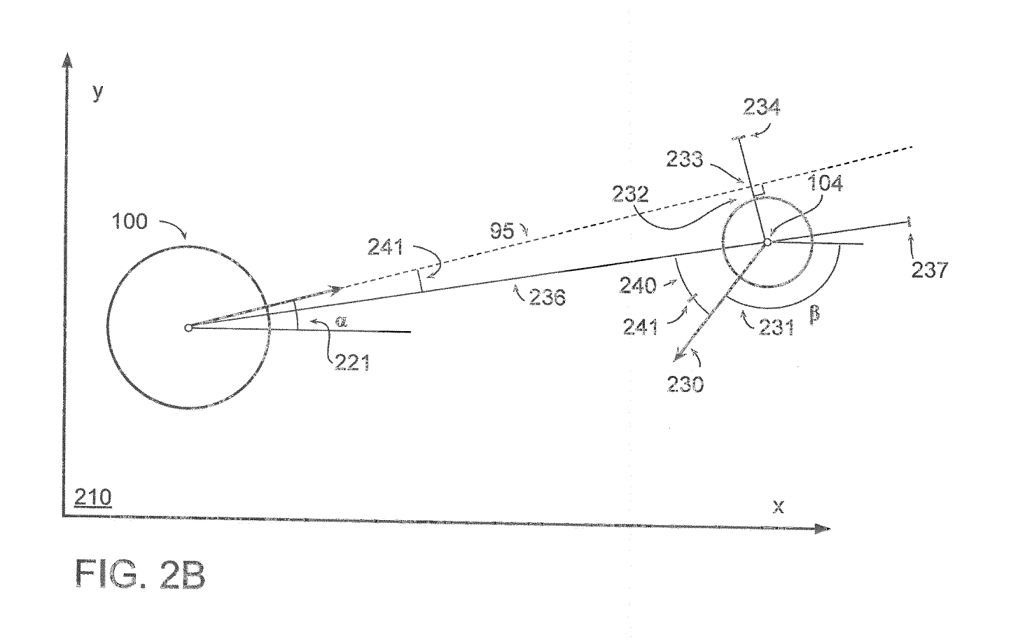

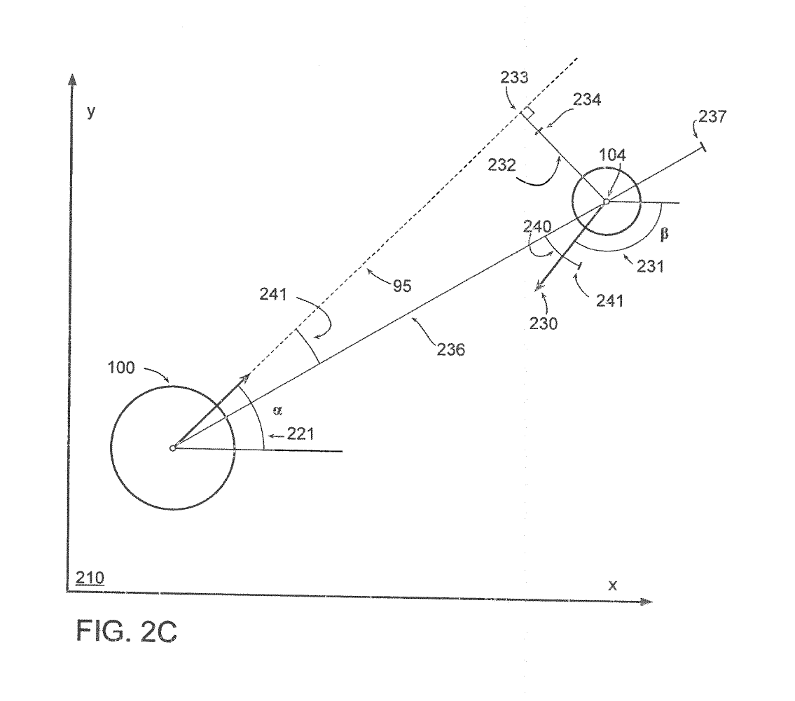

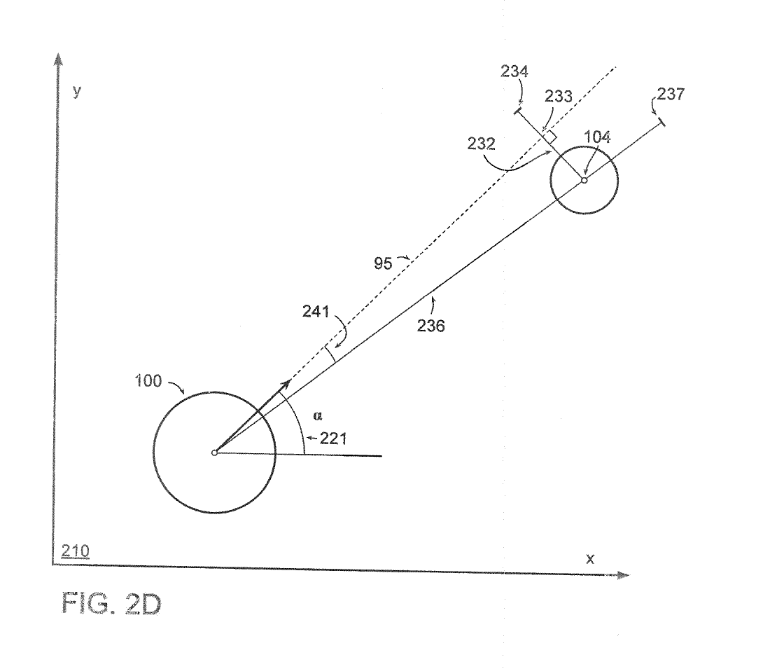

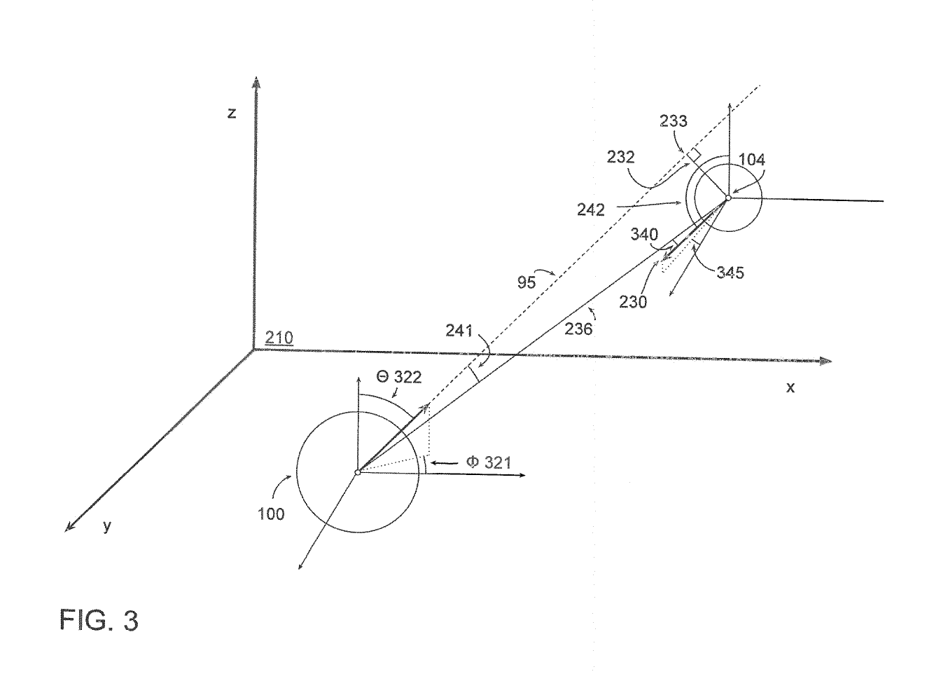

Staying with FIGS. 1A-1F, and before discussing FIGS. 2A-2D and 3, a “Point of Interest (PoI)” 104 represents any point that can be of any interest to the user, and can be of various natures. One or more PoIs may coincide with a controlled system, such as a TV (television) or an industrial unit. As another example, a PoI may be something for which a user wants to obtain information, such as a monument, an artwork in a museum, a bus or even a geo-localized worker moving through a construction site. Yet in another example, a PoI can be an ad-hoc object designed to work with the present invention, such as signs, mounted on walls, posts, hanging signs and fixtures and the like.

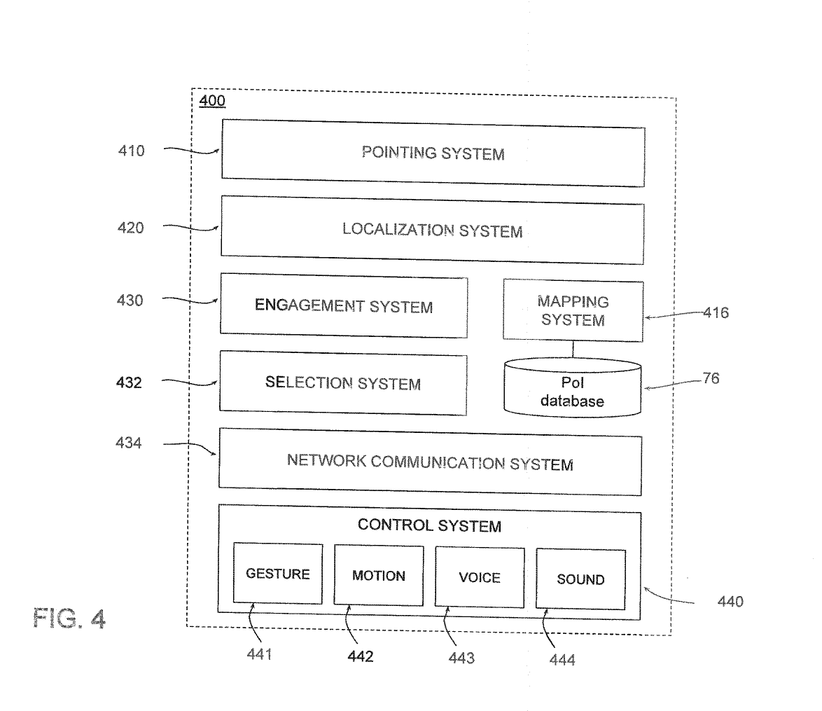

The Points of Interest have coordinates in the reference system of the localization system (420 FIG. 4, detailed below). In addition to the spatial (linear) coordinates, the PoI 104 may contain orientation (angles) coordinates, thus defining a point oriented in space. For example, a point of interest (PoI) may be the north side of a building; in this case, in addition to the spatial coordinates that identify the location of the building in the city, a geomagnetic (azimuth) coordinate is provided, so that this PoI 104 is engaged only by pointing the north side of the building. As another example, a point of interest (PoI) 104 may be the surface of a table. In this case, the point of interest (PoI), as the table surface, is engaged only by pointing, for example, to the table from above.

The coordinates of a PoI 104 may be constant or variable in time. For example, a PoI related to a bus stop or other pole has a constant position in time. Alternately, whenever a point of interest, such as that related to a city bus, which moves, has coordinated time-varying characteristics, such as a known schedule, or through an automatic vehicle location system.

FIG. 2A is an illustration of the engagement of an oriented PoI 104 through two dimensional (2D) localization and 2D pointing. User 100 is positioned, in the reference system 210. Through the pointing device e.g., a smartphone of the mobile computing device system, the user 100 points in a direction that has an angle alpha 221. User position and user pointing define a vector 95 in the reference system 210. In this case, the Point of Interest (PoI) 104 is oriented, and its orientation vector 230 in the reference system has an angle beta 231. A cross-track distance error 232 is defined as the length of the segment orthogonal to vector 95, passing through the center of the PoI 104 and that has an end point in the intersection 233 between the segment 232 and the vector 95 and the other end point in the center of the PoI 104. A track error 240 is defined as the angular distance between the pointing vector 95 and the line passing through the user position and the center of the point of interest 104. A way to compute the track error is, for example, as 180 degrees minus the difference between angle alpha 221 and angle beta 231. If the following conditions are simultaneously satisfied: i) user has a linear distance 236 to the center of the PoI less than a linear threshold 237 (e.g., 100 meters); ii) the cross-track distance error 232 is less than another linear threshold 234 (e.g., 1 meter); and, iii) the track error 240 is less than an angular threshold 241 (e.g., 10 degrees), then the system recognizes that user 100, via the pointing device, e.g., smartphone 105 (e.g., FIG. 1B), is pointing to the PoI 104.

FIGS. 2B, 2C and 2D are based in FIG. 2A, with similar elements as detailed for FIG. 2A above, and differences specifically indicated.

In FIG. 2B, the user 100 is not engaging the PoI 104 because the track error 240 is greater than the angular threshold 241.

In FIG. 2C, the user 100 is not engaging the PoI 104 because the cross track error 232 is greater than the linear threshold 234.

FIG. 2D is an example of a successful engagement of a PoI 104 without orientation. In this example, the third condition enumerated in the description of FIG. 2A (i.e., a track error check) is not required.

FIG. 3 is an illustration of the engagement of a PoI 104 in a three dimensional (3D) space. User 100 is positioned in the reference system 210. Through its pointing device, such as a smartphone of a mobile computing device system, the user 100 points in a direction that has angle Φ (phi) 321 and θ (theta) 322 with respect the axes. User position and user pointing define a vector 95. In analogy with the previous example of FIG. 2A, the cross-track distance errors 340 and 345 are computed. If the following conditions are simultaneously satisfied: i) user 100 has a linear distance 236 to the center of the point of interest less than a defined threshold (e.g. 20 meters); ii) cross-track distance error 232 is less than another linear threshold (e.g. 30 centimeters); and, iii) the track-error 340 and 345 are less than an angular threshold (e.g. 10 degrees), then the system (of the mobile computing device system) recognizes that user 100 is pointing to the point of interest 104. In analogy with the 2D case, the 3D PoI maybe be not oriented. Accordingly, in this case, the third condition above is not required.

FIG. 4 is an illustration of the overall architecture of a system 400 of the present invention. The system 400 is also known as a computing system, and includes sub-systems or modules, for example, a pointing system 410, a localization system 420 (e.g., indoor or outdoor localization system), a mapping system 416 that communicates with the PoI database 76, and electronically maps the various PoIs (these PoIs 104 are represented by electronic objects, which are based on a set of coordinates as stored in the PoI computer database 76) based on their coordinates, an engagement system 430, a selection system 432, that selects the most appropriate PoI within a set, a networking communication system 434, that facilitates communication between the system 400 and the network(s) 72, and a control system 440, which communicates with remote controlled devices, for example, remote device 135 of FIGS. 1D and 1E. The control system 440 includes, for example, components such as those for gesture controls 441 (e.g., air gestures above the device), motion controls 442 (e.g., moving portable or wearable device in a certain way), voice controls 443, sound controls 444 (e.g., finger snap recognition, user blow recognition).

The system 400 may reside on one or more of the mobile computing device system, such as a smartphone, alone or linked to a smart band, smart watch or other computerized wearable, virtual and/or augmented reality headset, either alone or linked to a smartphone or other computerized device, one or more remote servers, such as remote server 78, or other remote devices, remote systems, computer components and the like. The system 400 includes processors, storage media, and other components (not shown), and can also use the processors, storage media and other components, e.g., operating systems, of the mobile computing device system devices, to perform the operations of the subsystems or modules, detailed herein. The processors typically are associated with storage/memory, that stores machine executable instructions associated with the operation of the aforementioned modules, as well as instructions associated with the methods, processes and operations disclosed for the invention.

The pointing (or tracking) system 410 is equipped, for example, with sensors to recognize its orientation in space, i.e., the angles to the reference system of the location system 420. These sensors may be, for example, an inertial measurement unit (IMU) with accelerometers, gyroscopes and magnetometers. Examples of devices generally equipped with pointing systems are mobile computing devices, such as smartphones, tablets, smart bands, smart watches, smart rings, smart remote controls, augmented/virtual reality headset. Also other kinds of wearables/portable devices could be easily equipped with a pointing device, such as hats, visors, audio guides, and the like.

The localization system 420 can be indoor or outdoor. These systems could be based on numerous technologies, such as, GPS, beacons, Bluetooth, WiFi®, geomagnetism and geolocation, optical, radio, sound, satellite, and the like.

A reference system (also known as a global reference system), which is part of the localization system 420, can be global or local. The global reference system provides the coordinates relative to the Earth, for example but not limited to, latitude, longitude and elevation, or in Cartesian coordinates (e.g., ECEF—Earth Centered, Earth Fixed). The local reference system provides the location with respect to a known reference system, for example but not limited to, in Cartesian or polar coordinates. This local reference system can be referred to the layout of the building, or open area, e.g., a park, where the system of the present invention is located. As another example, the origin of the local reference system may coincide with the position of the user 100. In this case, the user 100 is always positioned in the origin of the reference system.

The reference systems can be two-dimensional (2D—e.g., a point on a plane or on the Earth's surface), as shown in FIGS. 2A-2D, or three-dimensional (3D—e.g., a point in space), as shown in FIG. 3.

The actual coordinates of Point of Interest (PoIs) are dynamically computed through the mapping system 416 and stored in the PoI database 76. The mapping system 416 receives current position data, for example, of the mobile computing devices, such as smartphones, smart wearables, augmented and virtual reality headsets, from the localization system 420, and based on this information, the mapping system 416 maps the environment, creating an electronic map of the environment, and populates the PoI database 76.

The mapping system 416 maps the environment, typically creating an electronic map, in several ways. As an example, in a museum, the mapping system 416 recognizes the current room, obtains the position of works (e.g., an art works, such as a painting or sculpture) in the room from a remote server through a local network and updates the PoI database 76 with only the works in that particular room in the museum. As another example, a user would like to get information about nearby buses. The mapping system 416 queries a remote server through a network(s) 72, such as the Internet, obtains data about public transport nearby and populates the PoI database 76 with bus locations.

As another example, the mapping system 416 maps the environment by directly communicating with the devices in the surroundings, through machine to machine communication, for example, Bluetooth, WiFi, ZigBee or 5G. For example, in a museum, the mapping system 416 receives PoI data from emitting devices located on the works in the surroundings, or in a workroom, directly queries the working machinery in the surroundings. The mapping system 416 then maps the devices, in an electronic map, and populates the PoI database 76.

In another example, the mapping system 416 receives information from a local database, which does not use wireless communication. For example, in an open and non structured environment like a park, a user 100 would obtain information about the trees around him, by pointing at them, using a mobile computing device, such as a smartphone 105. The mapping system 416 would then query a database previously loaded on the same smartphone, to obtain data about plants in the surroundings, and then populate the PoI database 76.

The engagement system 430, functions to confirm that the user actually wants to interact with the pointed PoI. Indeed, the pointing operations towards a PoI is often not enough to start an interaction, since it could be happen accidentally. The engagement system 430 correlates locations of the mobile computing device system, including the mobile computing device(s) and pointing data and the PoI (e.g., mapped PoI), and should there be a correlation (e.g., the correlation is acceptable), for example, as the mobile computing device system, including the mobile computing device(s) and pointing data and the PoI (e.g., mapped PoI) are within a predetermined distance of each other or within a predetermined orientation of each other.

Depending on the context of use, the engagement action, taken by the engagement system 430, may vary. It could be a simple action as keeping the wrist-worn device steady towards the PoI for a certain time (e.g., 2 seconds), that is appropriate when the engaging has to be fast, as, for example, in a museum pointing towards an art work. Or could be more complex, as a voice command (e.g., user says “what's there”), or a finger snap (e.g., recognized through device microphone), or a motion gesture (e.g., drawing a circle on the air, or twist the wrist twice).

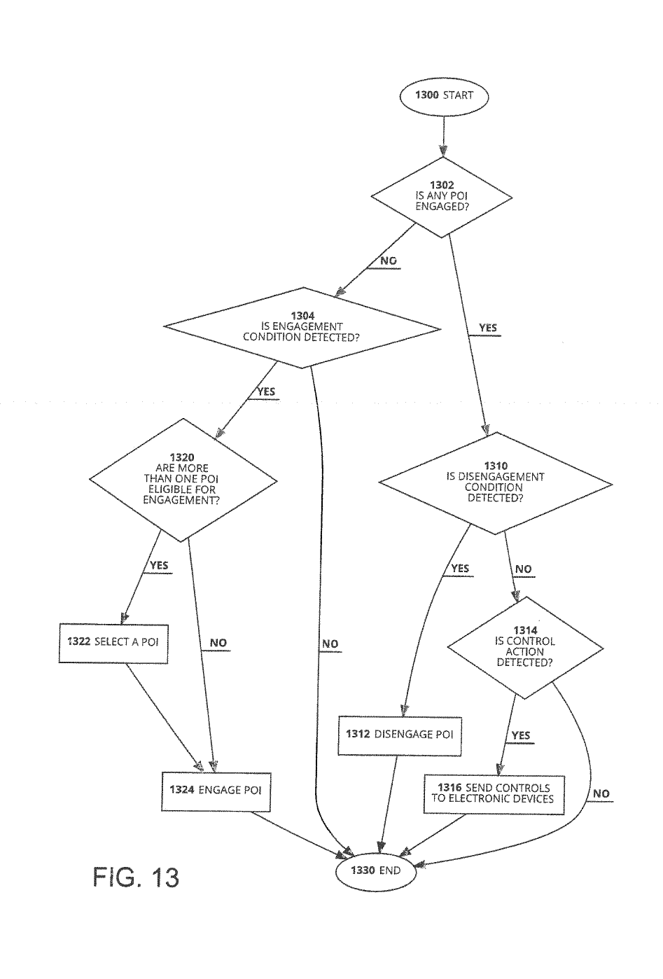

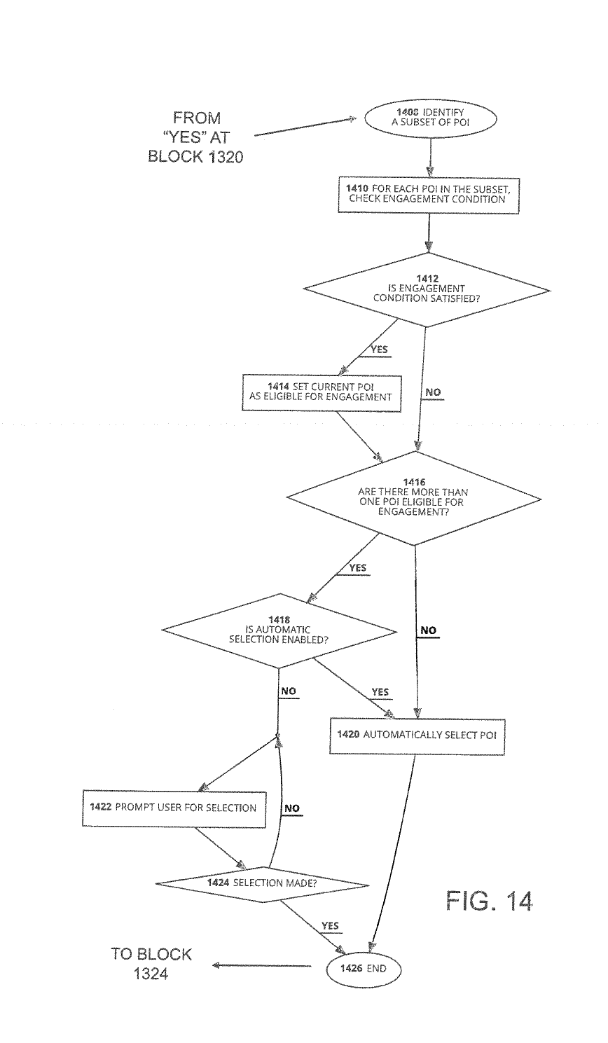

The selection system 432, functions to disambiguate if more than one PoI could be engaged in a specific time. For example, it may happen that two or more PoIs are close in space, or on the same line-of-sight, and when the user points in a certain direction and make the engagement action, more than one PoI satisfies the conditions to be engaged. In this case, the selection system 432 activates. There may be several selection strategies: the easiest is prompting the user 100 for selection. The user 100 may select the proper PoI by using the control system 440. Other selection strategies may include the selection of the closest PoI, or the PoI with minimum track and cross-track error, or according to a sorting algorithm or program, for example, as shown in FIGS. 13 and 14, and described below. The sorting algorithm or program may use, for example, ratings of other users on that PoI (e.g. PoI are restaurants), arbitrary sorting by the PoI database manager (e.g. PoI are store items), or sorting based on user profiling (e.g. PoI are places to visit).

The control system 440 can be composed by a traditional interface based on the touch of one or more fingers, for example, on a touch screen, such as that of a mobile computing device, such as a smartphone 105, or through a system of interaction without touch. In the case of touch interaction, the control system may be constituted for example, but not limited to, by touchscreen, touch-pad, keys, buttons, levers, and the like, of the smartphone 105 a remote control, a tablet computer, a smart watch, a control panel, and the like.

The control system 440 may include modules for different interaction modalities, such as gestures 441, motion 442, voice 443, sounds 444, or a combination of the above. In the case of voice controls 443, the control system 440 includes one or more microphones and methods of speech/voice recognition. In the case of sound controls 444, the control system 440 includes one or more microphones and methods of recognition of sounds, such as a snap, a clap or a blow, and sound patterns. In the case of motion controls 442, the system includes one or more inertial sensor, as accelerometer, gyroscope, magnetometer and the like, or a combination of them.

In the case of the gestures 441, a dedicated system for the recognition of gestures is included. This system consists of one or more sensors for tracking the movements of the user 100, of a vocabulary of gestures and of matching methods. Tracking sensors can be, for example, an inertial platform with accelerometers, gyroscopes and magnetometers, an electromyograph, a proximity sensor, and the like. Possible movements that can be tracked are, for example, the movement of a hand, a finger, an arm, the head, the whole body, and the like. The vocabulary of gestures can be predefined for a general audience or tailored according to each specific user. Matching methods compare tracking data with the vocabulary of gestures, in order to recognize the gesture performed by the user 100.

The control system 440 controls devices, such as electronic devices 135, which are capable of delivering and interacting with multimedia content, such as a smartphone (which is different from the smartphone, such as smartphone 105, on which the control system 440 resides), a tablet computer, a TV (television), a PC (personal computer), a projector, a media panel, or a combination of the above. As another example, the controlled system can be an infotainment system for cars, airplanes, boats and other moving vehicles. In situations such as exhibitions and shopping malls, the controlled system can be one or more tailored devices, such as the lights of a display, an art installation, and the like. In a working/industrial situation, the controlled system may be industrial machinery, such as a mechanical arm, a conveyor belt, as well as devices for making emergency calls and/or help and/or support requests.

Each PoI 104 could be associated to one or more of the aforementioned controlled devices, such as controlled devices 135. In order to interact with controlled devices, the system of the present invention operates in three phases: engagement phase, control phase, disengagement phase.

The first or engagement phase enables the coupling of the control system 440 with the controlled device or devices. The control system 440, performs, for example, the following operations. Through the localization system 420, the current coordinates of the user (user's device, e.g., smartphone 105, smart band 115, smart watch 116, augmented or virtual reality headset 118) are computed. Through the pointing (tracking) 410 system, angles between user pointing directions and axes of the reference system (of the localization system 420) are computed. Pointing vectors are calculated using current coordinates as the origin of the vector and angles for orientation. If necessary, for example, in case of large PoI database 76, a subset of the PoI is selected, for example, only PoIs proximate or close to the user 100. Then, for each PoI 104 in the database 76 or subset of PoIs, the following parameters, for example, are checked, for example, by the engagement system 430): 1) distance between the user 100 and the PoI 104 (e.g. max 100 m), 2) the cross-track distance error between pointing vector and PoI 104 (e.g. max 1 m), and optionally, only if the PoI contains orientation data, 3) angular distance between the pointing vector and PoI 104 orientation (e.g. max 10 degrees). If these parameters fall within acceptable and typically predetermined, thresholds, the PoI 104 is eligible for engagement. To engage a eligible PoI 104, if a confirmation (engagement) action is required, the user 100 must perform the confirmation (engagement) action. Otherwise, if a confirmation action is not required, the PoI 104 is automatically engaged. The confirmation action is performed through the control system 440 and can be realized in one of the ways disclosed by the invention herein, for example, a voice command, a gesture and the like.

Referring to the previous example, the user 100 has a smartphone 105 and a wrist-worn device 115/116 (e.g., a smart-band or a smart-watch) (mobile computing devices of the mobile computing device system). Another way of computing the pointing vector is as follows. The localization system 420 computes the coordinates of both the smartphone 105 and the wrist-worn device. The pointing vector is computed as the vector starting from the smartphone 105 and passing through the wrist-worn device 115/116.

Once engaged, the control system 440 enters in the control phase, or second phase. During the control phase, is not necessary to keep pointing to the Point of Interest 104. In this phase, the user 100 leverages the control system 440 to control the controlled device or devices 135. Possible commands are, for example, those for: obtaining information about the point of interest 104, media controls (play/stop/pause), motion controls (right, left, up, down), selecting an item from a list, or specific controls such as calls for help, shut-off of equipment, and the like.

The disengagement or third phase follows the control phase. In this disengagement phase, the user 100 is decoupled from the PoI, and thus from the controlled device or devices 135 (if any). The disengagement can be automatic, e.g., after a predetermined time period (e.g., 30 seconds), or upon exiting from an area (e.g., a room), or by no-longer pointing the PoI, or manually, through a voluntary disengagement command, e.g. voice command (“OK DONE”) or gesture command (drawing an X in the air, or shaking the device, e.g., smartphone 105 and/or smart band/watch 115/116).

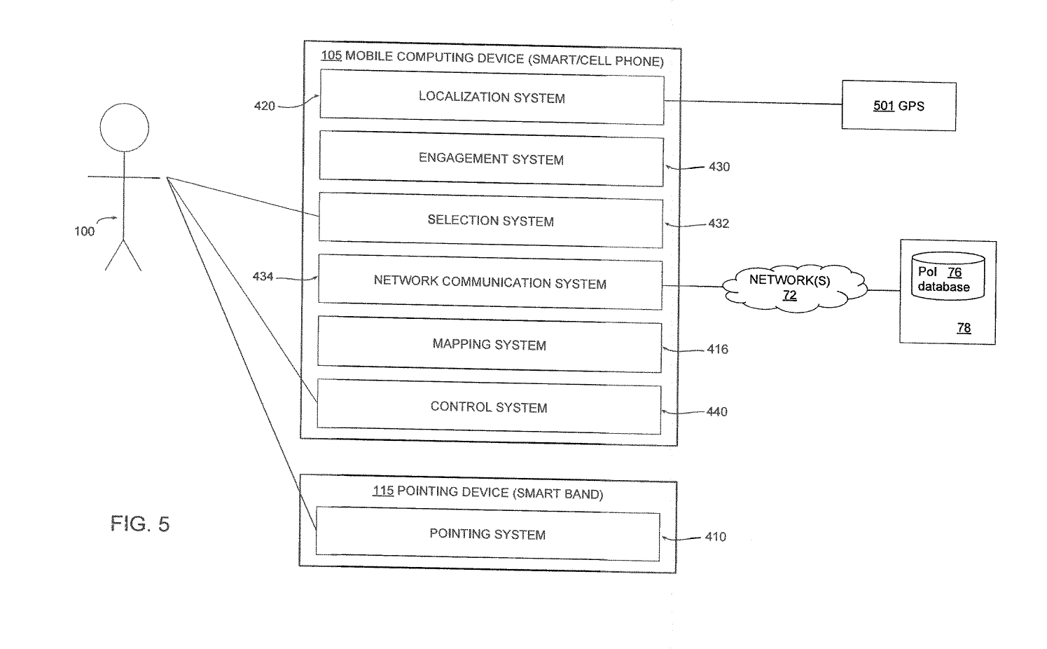

FIGS. 5-10 are exemplary systems based on the system of FIG. 4, as detailed above. Element numbers if components of these systems are the same as those shown in FIG. 4, and are in accordance with the descriptions of the system 400 of FIG. 4. Differences between the exemplary system of FIGS. 5-10 from FIG. 4, are noted in FIGS. 5-10.

FIG. 5 is an example of system where the pointing system 410 is located in a dedicated electronic device 115, such as a wrist worn smart band 115. The mapping system 416, which resides on the mobile computing device, e.g., a smartphone 105, of the mobile computing device system, links to a PoI database 76, on a remote server 78, via the network 72. Also in this embodiment, the content related to PoI is shown on the mobile computing device 105, via the speakers, to play an audio guide. In this example, the localization system makes 420 use of external localization service GPS 501. The engagement system 430, selection system 432, network communication system 434 and control system 440, reside on the mobile computing device 105.

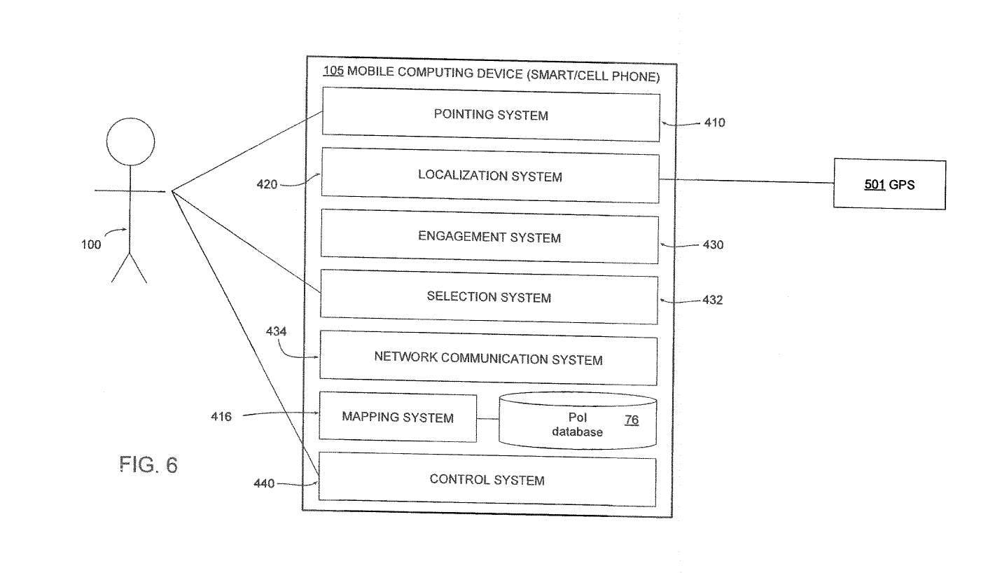

FIG. 6 is an example of system where all subsystems, for example, the pointing system 410, the localization system 420, the engagement system 430, the selection system 432, the network communication system 434, mapping system 416, which is linked to the PoI database 76, and the control system 440, reside on the mobile computing device, for example, a smartphone 105. Like that of FIG. 5, the localization system makes 420 use of external localization service GPS 501.

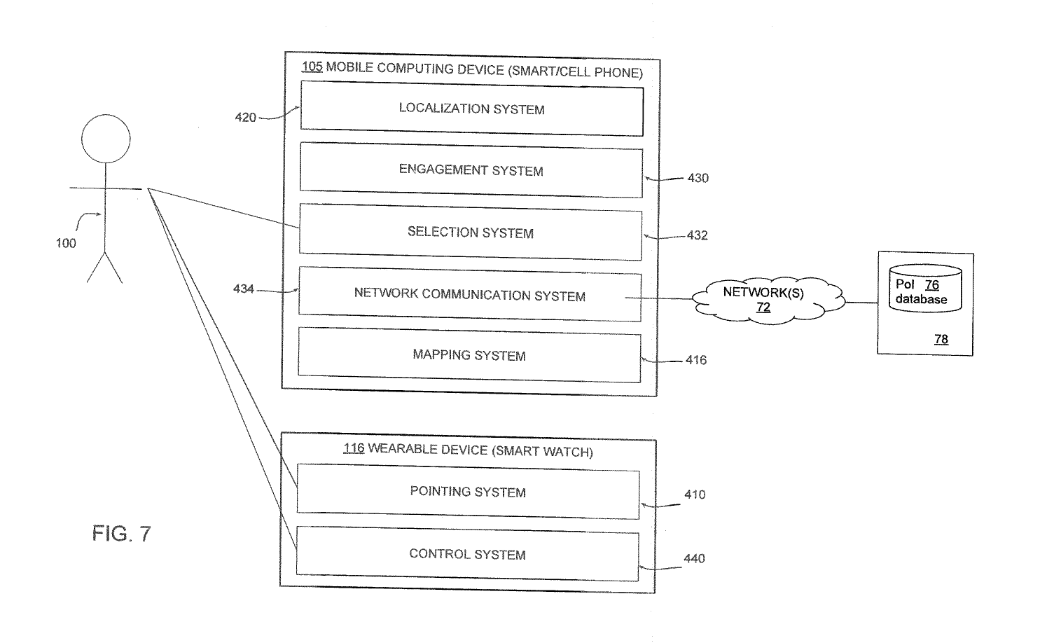

FIG. 7 is an example of system where the mobile computing device system includes, for example, mobile computing devices such as a smart watch 116 or other computerized wearable, and a smartphone 105. The pointing system 410 and the control system 440 are located in a dedicated device 116 (e.g., a smart watch but could also be a smart band 115). The localization system 420 does not use external services for localization, but use only on-board sensor, as magnetometer to recognize geomagnetism. The localization system 420, engagement system 430, selection system 432, and, network communication system 434, and the mapping system 416, reside on the mobile computing device, e.g., a smartphone 105, of the mobile computing device system. The network communication system 434 links to a PoI database 76, on a remote server 78, via the network 72.

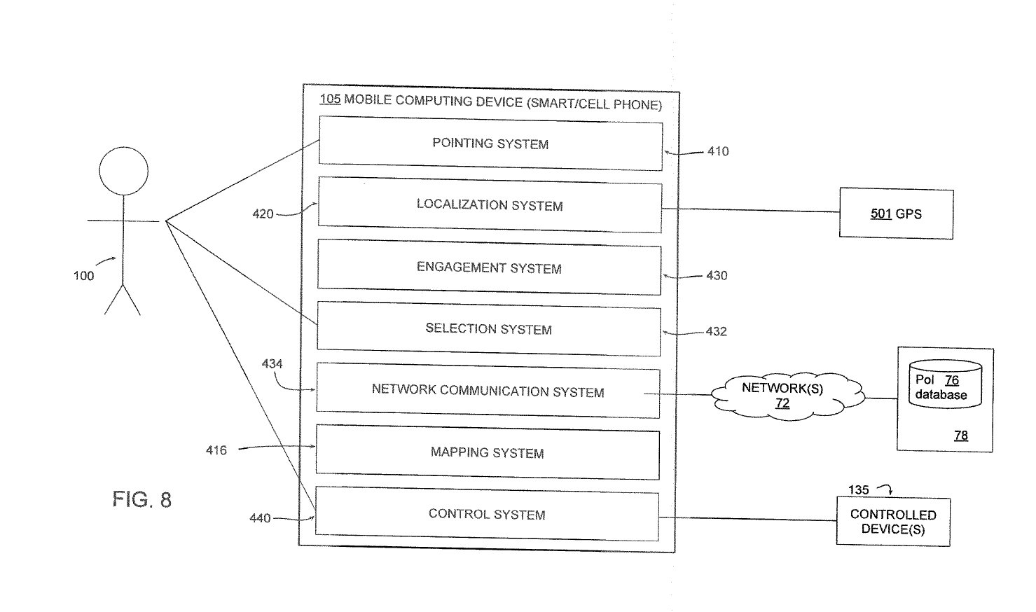

FIG. 8 is an example of system similar to that of FIG. 6, where the control system 440 controls one or more remote devices 135 with by direct communication. Also, optionally, should the PoI database 76 not reside on the mobile computing device, e.g., smartphone 105, the network communication system 434 links to a PoI database 76, on a remote server 78, via the network 72.

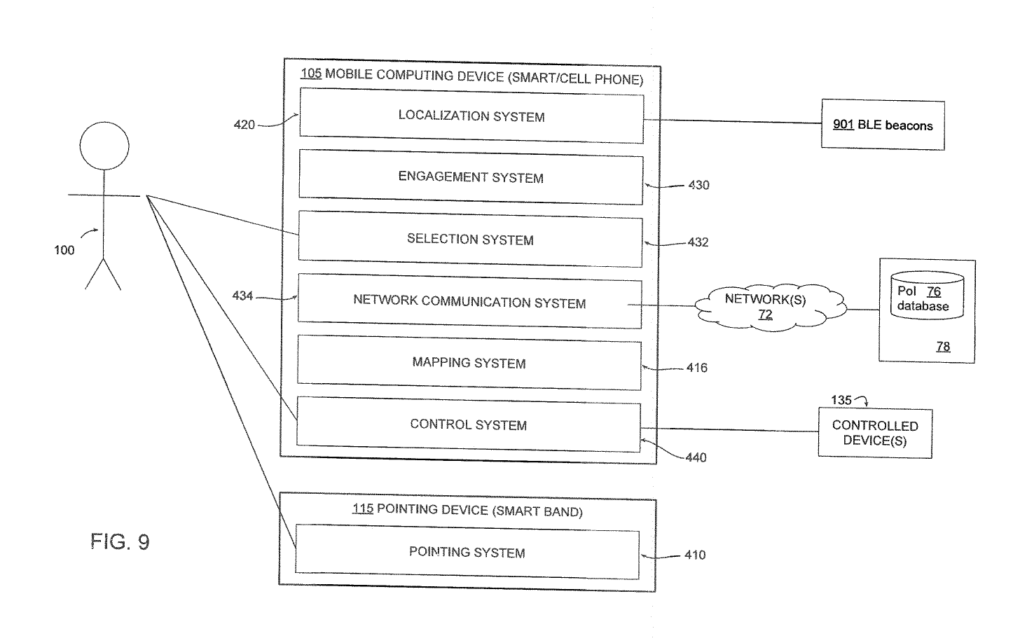

FIG. 9 is an example of system where the control system 440 controls one or more remote devices 135 with a connection to the PoI database 76 on a remote server 78 mediated by a network 72. In this example, the localization system 420 makes use of BLE (Bluetooth® Low-Energy) beacons 901 for localization. In this example, the controlled devices 135 have the capability of auto-localization and communicate their position to the mapping system 416 through a wireless communication system, e.g., 5G or ZigBee.

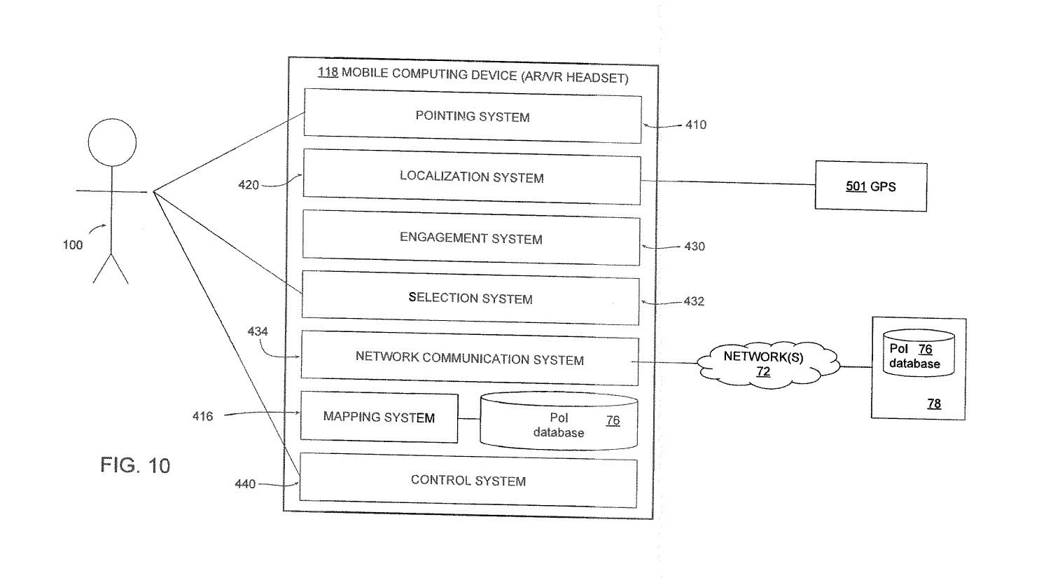

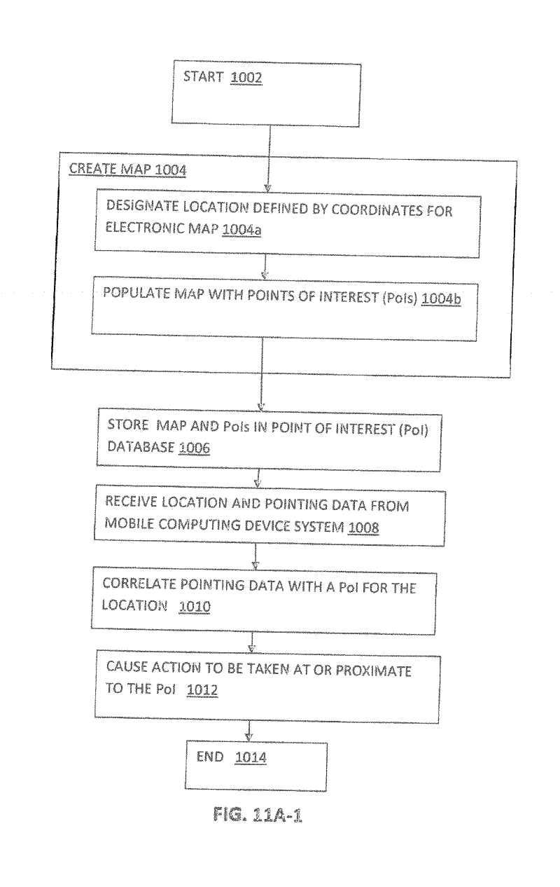

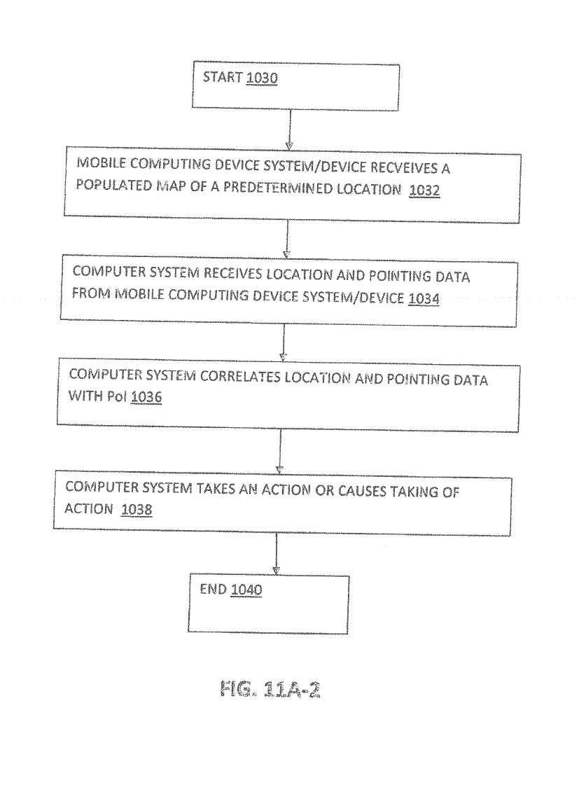

FIG. 10 is an example of system where the mobile computing device is an augmented/virtual reality headset 118, similar to the smartphone 105 of FIG. 6, on which the pointing system 410, the localization system 420, the engagement system 430, the selection system 432, the network communication system 434, mapping system 416 (the mapping system 416 which is linked to the PoI database 76), and the control system 440, reside. The localization system makes 420 use of external localization service GPS (Global Positioning System) 501. Optionally, should the PoI database 76 not reside on the mobile computing device 118, the network communication system 434 links to the PoI database 76, on a remote server 78, via the network 72.

Attention is now directed to FIGS. 11A-1, 11A-2, 11A-3, 11B, 11C, 12, 13, 14 and 15, which show flow diagrams detailing computer-implemented processes in accordance with embodiments of the disclosed subject matter. Reference is also made to elements shown in FIGS. 1A-1F and 2-10. The process and subprocesses of FIGS. 11A-1 to 11A-3, 11B, 11C, 12, 13, 14 and 15, include computerized processes performed by mobile computing devices, such as smartphones, smart bands, smart watches and other smart wearables, and augmented reality/virtual reality headsets, and other computerized devices. The aforementioned processes are, for example, performed automatically or manually, or a combination thereof, and, for example, in real time.

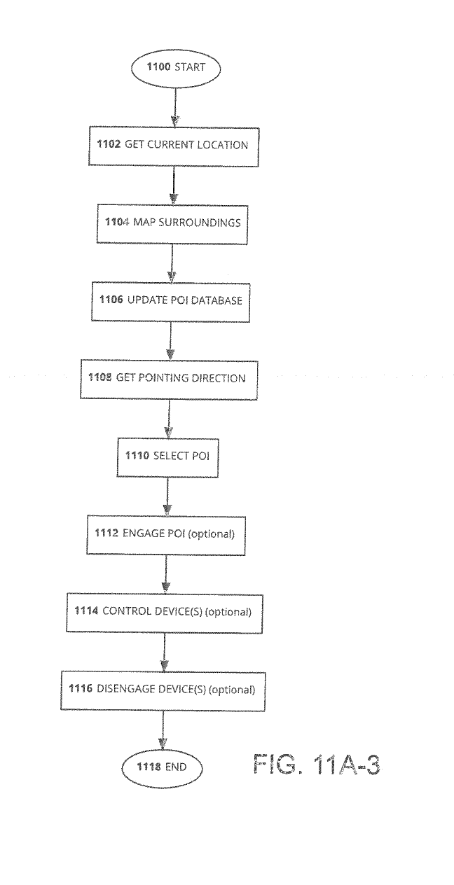

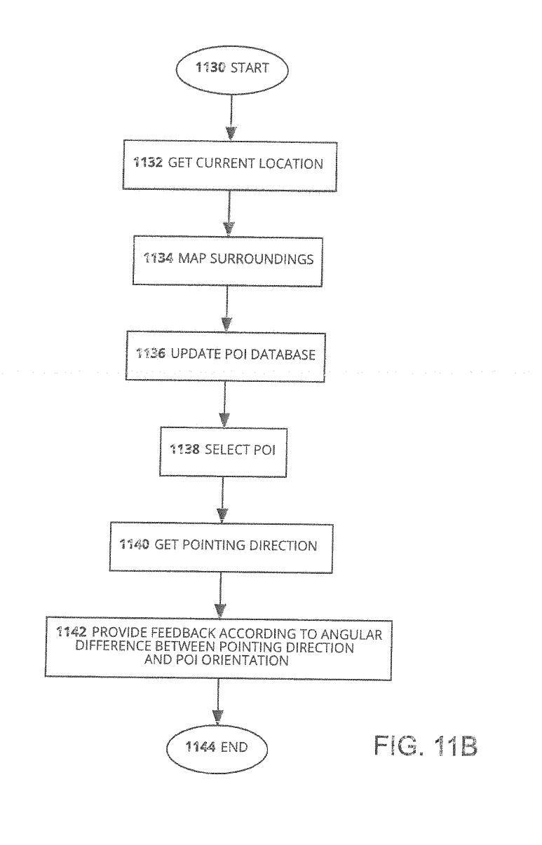

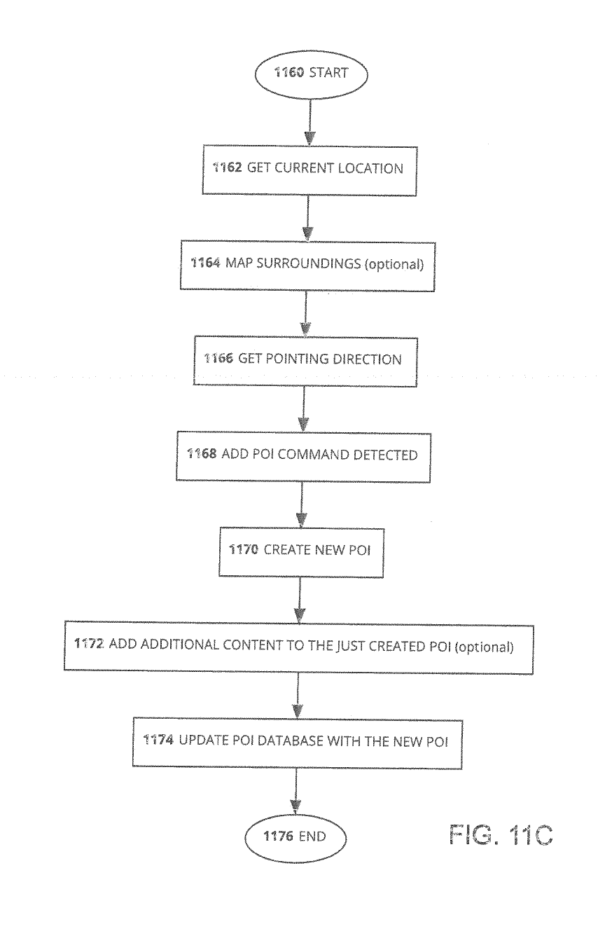

FIG. 11A-1 shows an embodiment of overall operations of the system 400. The process begins at a START block 1002. The process moves to block 1004, where a map, e.g., an electronic map is created. At this block, a location is defined by coordinates for the electronic map, at block 1004a, and then, the map, e.g., electronic map is populated with points of interest (PoIs), at block 1004b. The process moves to block 1006, where the map, e.g., electronic map, and PoIs are stored in the PoI database 76, or other storage media associated with the system 400.

The process moves to block 1008, where the system receives location and pointing data from a mobile computing device system, such as such as smartphones, alone or linked to smart bands, smart watches and other smart wearables, and augmented reality/virtual reality headsets, alone, or linked to smart bands, smart watches and other smart wearables. Next, at block 1010, the system 400 correlates the pointing data with a PoI for the location, the correlation for example, being the locations of the mobile computing devices and PoI within a predetermined distance or range of each other. With there being a correlation, the process moves to block 1012, where the system 400 causes action to be taken proximate to the PoI. This action may be, for example, the mobile computing device controlling an electronic device or electronic devices, or the mobile computing device receiving data from or about the PoI. With the process complete, it moves to block 1014, where it ends.

FIG. 11A-2 shows an embodiment of another overall operation of the system 400. The process begins at a START block 1030. The process moves to block 1032, where a mobile computing device, e.g., smartphone, or mobile computing device system, e.g., smartphone linked to a smart band or the like, receives a populated map, e.g., electronic map, of PoIs at a predetermined location. The system 400 then receives location and pointing data from the mobile computing device or mobile computing device system, at block 1034. The system 400 then correlates location and pointing data with a mapped PoI, at block 1038. With there being a correlation of locations, the process then moves to block 1038, where the system 400 takes an action. This action may be, for example, the mobile computing device controlling an electronic device or electronic devices, or the mobile computing device receiving data from or about the PoI. With the process complete, it moves to block 1040, where it ends.

FIG. 11A-3 is a flow diagram of the overall operations of the system 400, in accordance with any of the examples of FIGS. 5-10. Initially, at the START block 1100, the system 400 initially localizes itself. The process moves to block 1102, the system computes its position 1102 and maps the surroundings 1104. The process then moves to block 1106, where the PoI database 76 is updated with additional PoIs 104 or PoIs removed from the respective electronic maps. A pointing direction for a mobile computing device is received, at block 1108, and a PoI associated with the pointing direction is selected at block 1110, by a correlation of device location and the electronic map. At this point, the user may engage one or more devices (via engagement of the PoI), at block 1112, and in this way he can control the engaged device or devices, at block 1114. When the user has finished controlling the desired devices, these devices can be disengaged, at block 1116. The process ends at block 1118.

FIG. 11B is an alternative operational diagram of the system 400, in accordance with any of the examples of FIGS. 5-10. This process begins at the START block 1130, where at least one PoI must be present in the PoI database 76, in order to be selected and receive feedback. The process moves to block 1132, where the current location to be mapped is obtained. The surroundings of the location are mapped into an electronic map at block 1134, and the PoI database 76, is updated, at block 1136, to include the mapping of the PoIs in the electronic map for the designated location.

At block 1138, the selection of a PoI by a user (via their mobile computing device, such as their smartphone 105 and/or smart band 115) is received, along with the pointing direction of the mobile computing device, at block 1140. The process moves to block 1142, where the system 400 provides feedback according to the angular difference between the pointing direction and the PoI 104 orientation. This results in at least one of a visual, tactile or audio indication, which can be such that vibrations increase or volume increases, as the user's pointing gets closer to the PoI. The process ends at block 1144.

FIG. 11C is an another alternative operational diagram of the system 400, in accordance with any of the examples of FIGS. 5-10. This process begins at the START block 1160, where at least one PoI must be present in the PoI database 76, in order to be selected and receive feedback. The process moves to block 1162, where the current location to be mapped is obtained. The surroundings of the location are mapped into an electronic map, optionally, at block 1164. The pointing direction of the mobile computing device is then obtained, at block 1166. The process moves to block 1168, where an additional PoI command is detected. This additional command is to add a new PoI to the PoI database 76. This command includes, for example, the user keeping the smart band 115 steady for more than a predetermined time, for example, two seconds, or a voice command as a “new point”, or a finger snap as recognized through the device's microphone, or a wrist twisting gesture.

The process moves to block 1170, where with the new PoI command detected, a new PoI is created, and added to the relevant electronic map. In an optional subprocess at block 1172, additional content is added to the newly created PoI. The process then moves to block 1174, where the PoI database is updated with the newly created PoI. The process then moves to block 1176, where it ends.

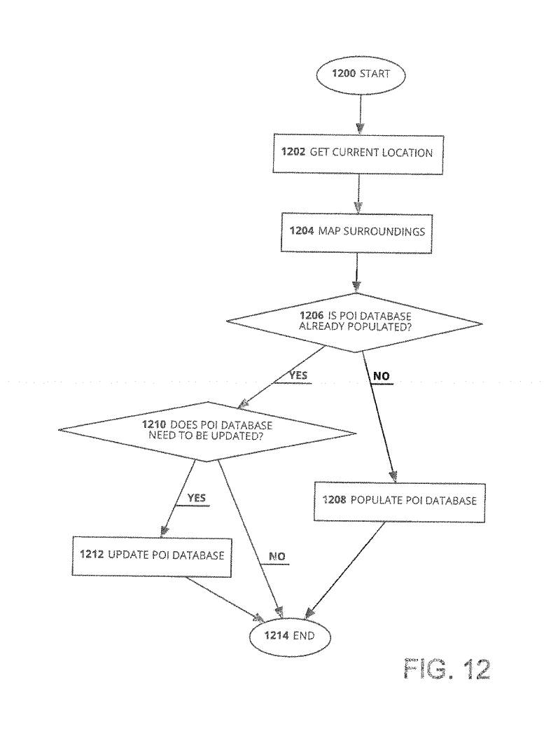

FIG. 12 is a flow diagram of a process for mapping of the environment and population of PoI database 76. The system 400 calculates the current location to be mapped, and then maps the environment. The process begins at the START block 1200. The process moves to block 1202, where the current location for which an electronic map with PoIs mapped therein, is desired. At block 1204, the surroundings, including PoIs are mapped in an electronic map. The process moves to block 1206, where it is determined whether the PoI database 76, has been populated with the mapped PoIs.

If no, at block 1206, the process moves to block 1208, where the PoI database 76 is populated with the mapped PoIs (of the now-created electronic map). From block 1208, the process moves to block 1214, where it ends.

If, at block 1206, the PoI database 76 is populated, the process moves to block 1210, where it is determined whether the PoI database 76 needs to be updated. If no at block 1210, the process moves to block 1214, where it ends. If yes, at block 1210, the process moves to block 1212, where the PoI database 76 is updated, as per updates to the electronic map. The process moves to block 1214, where it ends.

FIGS. 13 and 14 are flow diagrams of the engaging of a PoI and control of one or more devices. FIG. 14 shows the process of block 1322 of FIG. 13 in detail.

In FIG. 13, the process begins at the START block 1300 where the PoI database 76 and electronic map are updated and localization and pointing data have already been obtained. Initially, at block 1302, it is determined whether any PoI is engaged, for example, being pointed to and this pointing to is detected by the system. If a PoI is engaged, at block 1302, the process moves to block 1310. If a PoI is not engaged, the process moves to block 1304. At block 1304, it is determined whether there is an engagement condition, e.g., the user keeping the smart band, or other wearable, or smartphone, steady for at least a predetermined time, e.g., two seconds, a voice command, such as “Who is there”, a finger snap, as recognized through a microphone of the smart band, or a wrist twisting gesture. Should there not be an engagement condition detected, the process moves to block 1330, where it ends. Should there be an engagement condition, the process moves to block 1320.

Returning to block 1310, the system checks for a disengagement condition being met. If yes, the process moves to block 1312, where the PoI is disengaged, for example, by a voice command, such as “OK Done”, by a motion gesture, such as drawing an “X” in the air with the smart band 115 or other wearable, or smartphone 105, shaking the device (smart band 115 or smartphone 105) for a predefined time, for example, one minute, or when the user moves away from the PoI, such as leaves the room, or if the user (e.g., user device) is not pointing to the PoI anymore. From block 1312, the process moves to block 1330, where it ends.

Returning to block 1310, should a disengagement condition not be detected, the process moves to block 1314, where the system determines whether there is controlled action. Controlled action is, for example, motion gestures, air gestures, or voice commands to the device, to switch a channel, skip a track, change volume, resume a program, broadcast or the like. If no, the process moves to block 1330 where it ends. If controlled action is detected, the process moves to block 1316, where commands are sent to electronic devices, to be controlled. The process then moves to block 1330, where it ends.

Returning to block 1320, where the system 400 determines whether there are more than one PoI eligible to be engaged. If yes, the process moves to block 1322 where the system selects one PoI, typically by prompting the user, or selecting the closest PoI, or the most relevant PoI according to a sorting process, for example, as detailed in FIG. 14 (discussed below). The process then moves to block 1324, where the PoI is engaged. If at block 1320, the system determined that there are not more than one engagable PoI, the process moves to block 1324, where the PoI is engaged. At block 1324, commands are sent to electronic devices, to be controlled. From block 1324, the process moves to block 1330, where it ends.

FIG. 14 is a process for determining the most relevant PoI 104, and is a block 1322 of FIG. 13 in greater detail. The process begins at block 1408, from the “YES” of block 1320 of FIG. 13. At block 1408, a subset of one or more PoIs is identified. The process moves to block 1410, where the engagement condition is checked for each PoI in the subset. It is then determined, whether each engagement condition is satisfied, at block 1412. Should engagement conditions be satisfied, the process moves to block 1414, where the current PoI is set as eligible for engagement. The process then moves to block 1416. Should engagement conditions not be satisfied, the process moves to block 1416.

At block 1416, it is determined whether there is more than one PoI eligible for engagement. If there is not more than one PoI eligible for engagement, the process moves to block 1420 If there is more than one PoI eligible for engagement, the process moves to block 1418 where it is determined whether automatic selection of the PoI is enabled. If yes, the process moves to block 1420, where the PoI is automatically selected.

From block 1420, the process moves to block 1426, where it ends, and the process returns to block 1324 of FIG. 13.

Returning to block 1418, should the automatic selection not be enabled, the process moves to block 1422. At block 1422 the system prompts the user to make a selection, select a PoI. The process moves to block 1424, where the system determined whether a selection has been made by the user and the system has received this selection. If no at block 1424, the process returns to block 1422 from where it resumes. If yes at block 1424, the process moves to block 1426, where it ends, and the process returns to block 1324 of FIG. 13.

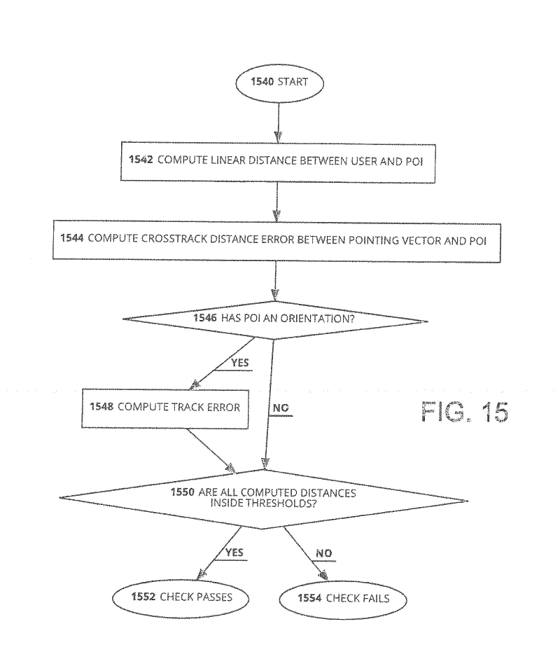

FIG. 15 is a detailed flow diagram of an example of the engaging of a PoI. At the START block 1540, where the PoI database 76 and electronic map are updated, and localization and pointing data have been obtained. The process moves to block 1542, where the linear distance between the user and the PoI is computed. Next, at block 1544, the cross-track distance error between a pointing vector e.g., the pointing vector in the pointing direction 95 of the wrist-worn device (e.g., smart band, and the PoI 104 (FIG. 2A)) is computed.

The process then moves to block 1546, where it is determined whether the PoI is oriented. If the PoI is oriented, the process moves to block 1548, where the track error is computed. The process then moves to block 1550. At block 1546, if the PoI is not oriented, the process moves to block 1550.

At block 1550, it is determined whether all computed distances are within thresholds. If within a threshold, the check passed, at block 1552 and the selected PoI is engaged. Otherwise, if the values are not in thresholds, the check fails at block 1554, the next PoI is chosen as a candidate for engagement, and the process returns to the distance computation operations (of block 1544).

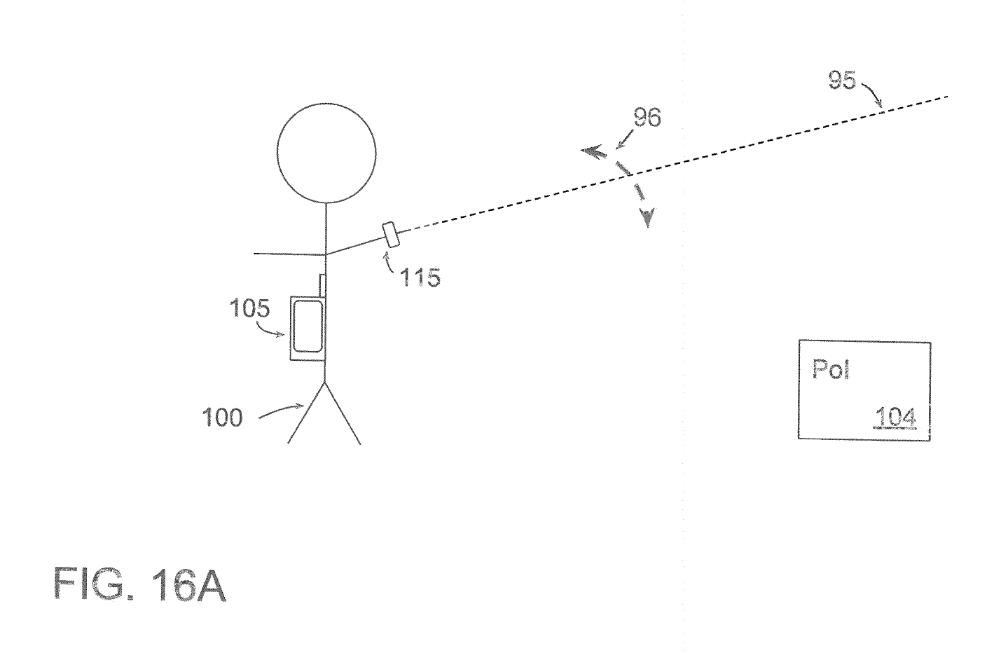

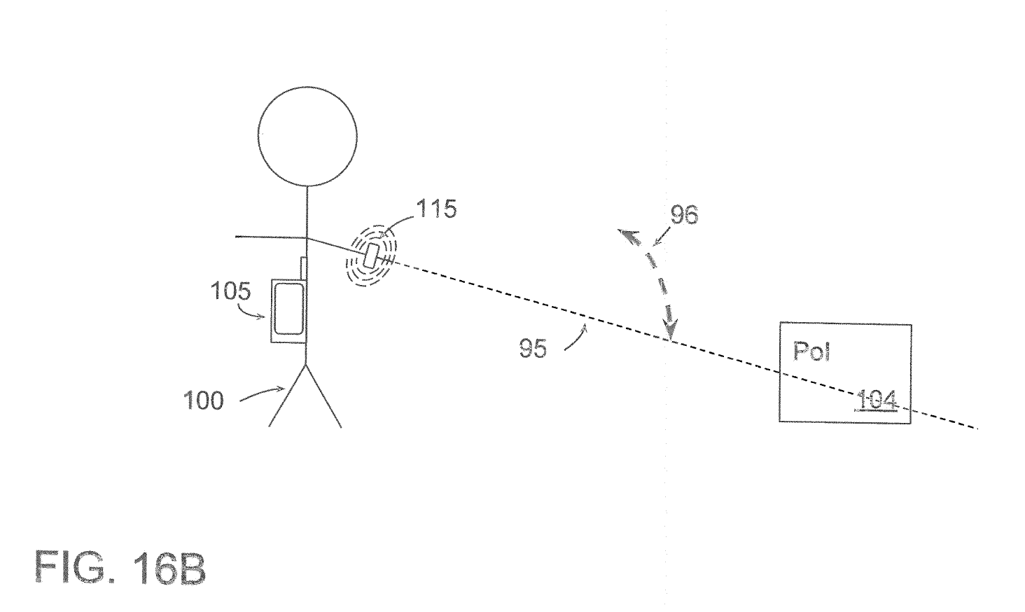

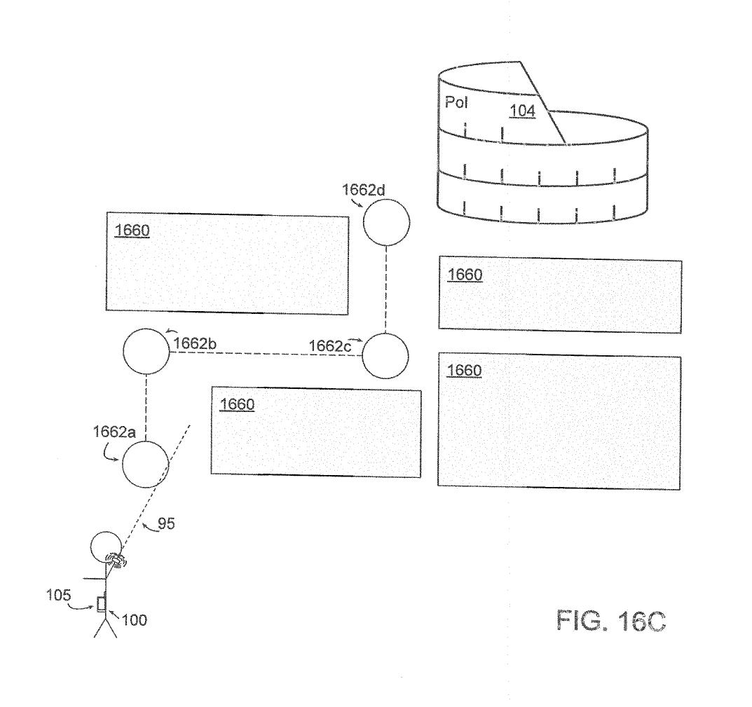

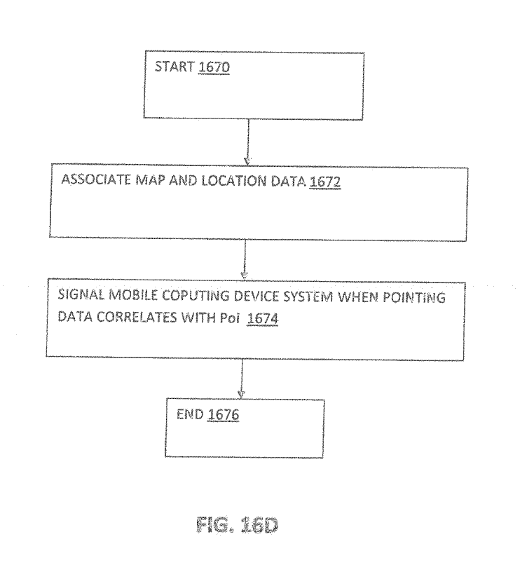

Attention is now directed to FIGS. 16A and 16B. In FIG. 16A, a user 100 with his smart band 115 (linked to his smartphone 105) makes a movement over an arc range 96 while pointing to a PoI 104. Once the pointing direction is correct, the system 400, residing for example in the smartphone 105, correlates the pointing direction of the smart band 115 with the correlated locations of the smartphone 105 and PoI, as mapped in the PoI database, and the smart band 115 vibrates, indicating the proper pointing direction of the PoI 104.

FIG. 16C is an embodiment which is variation of the embodiment of FIGS. 16A and 16B. Here, a user 100 is attempting to reach a PoI 104, for example, the Coliseum in Rome. This PoI 104 is electronically mapped along with the location of the buildings 1660, in a PoI database, which is, for example, residing on the smartphone 105 (the smartphone 105 is lined to the smart band, as shown and discussed for FIG. 1A above). The user 100 points his smart band toward the PoI 104, in the pointing direction 95, but due to the buildings 1660, the smart band vibrates, such that the user 100 is directed to a point 1662a and must walk straight to the point 1662b. At point 1662b, the user 100 again points the smart band 115 to the PoI 104 and is directed to walk to point 1662c. At point 1662c, the user 100 again points the smart band 115 to the PoI 104 and is directed to walk to point 1662d, from where the user walks to the PoI 104, the Coliseum.

FIG. 16D is a flow diagram of a process, used for example, in the embodiments of FIGS. 16A, 16B and 16C. The process begins at the START block 1670. The process then moves to block 1672, where location data of the mobile computing system, e.g., smartphone linked to a smart band or the like, is associated with an electronic map. The electronic map includes PoIs. The process moves to block 1674, where the system 400 signals (gives feedback to) the mobile computing device system (with mobile computing devices such as smartphones 105, smart bands/watches 115/116, and the like), when the received pointing data correlates with the relevant PoI on the electronic map, as determined, for example, by the engagement system 430. The signaling may result in tactile, e.g., vibrations, sound, audio, visual or other indications at the mobile computing device, and becoming more concentrated, louder, frequent or intense, as the correlation becomes closer, e.g., a closer distance between the pointing data and PoI locations.

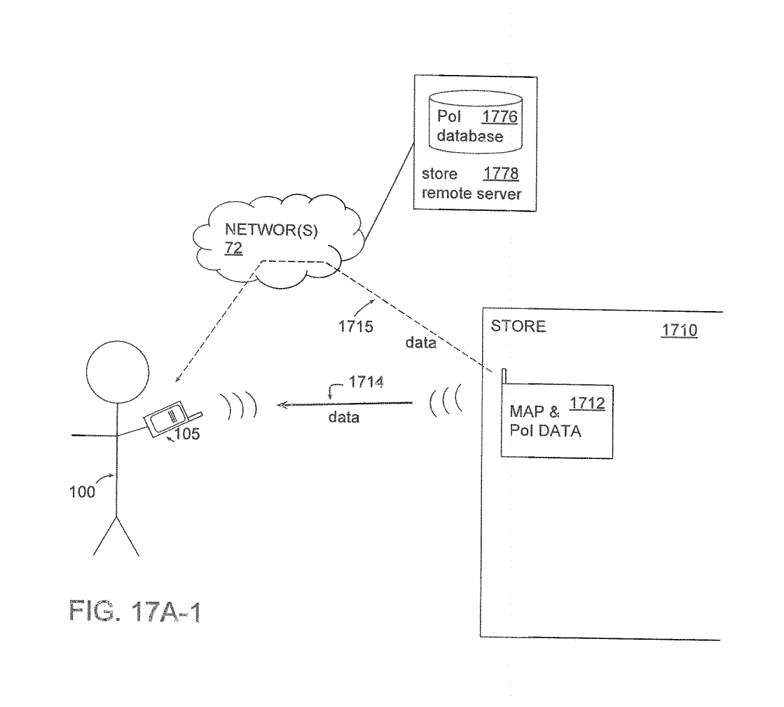

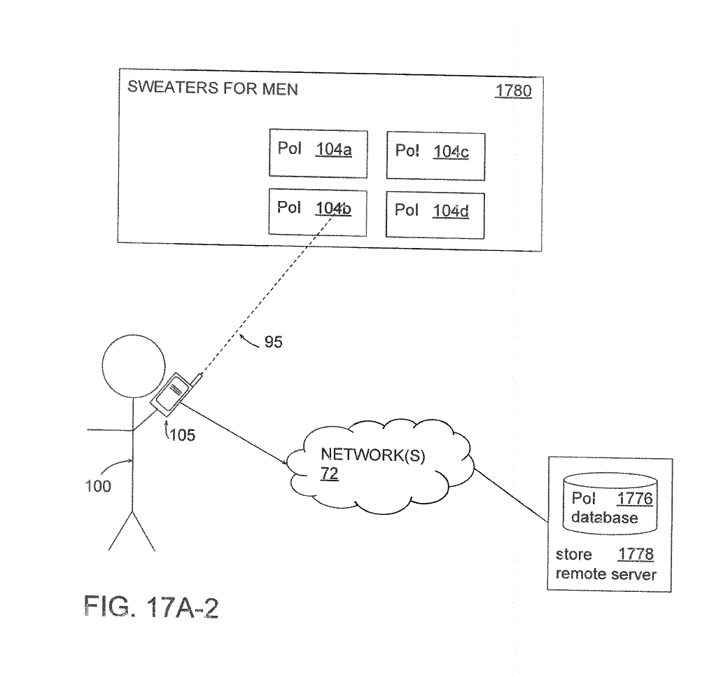

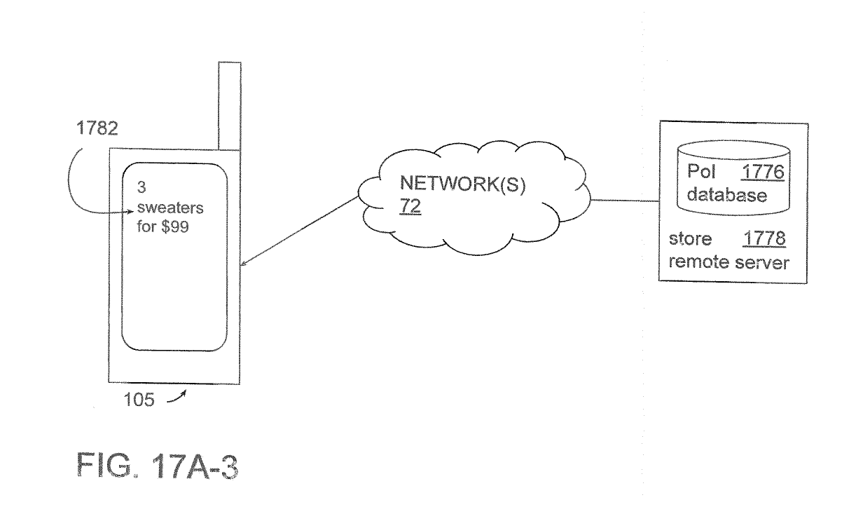

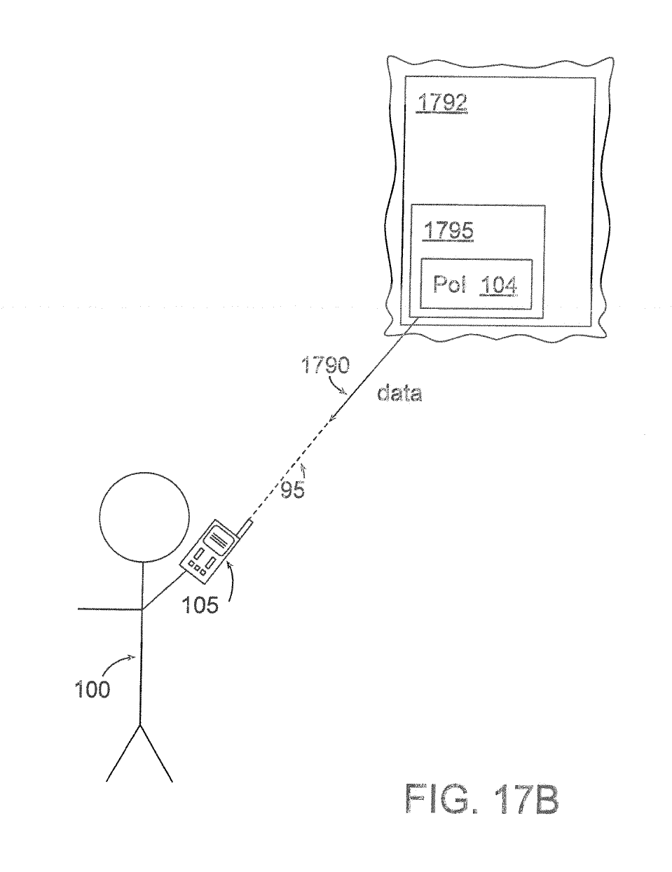

Another embodiment of the invention is shown in FIGS. 17A-1 to 17A-3. In FIG. 17A-1, a store or other retail outlet 1710 transmits map and PoI data to the mobile computing system, e.g., smartphone 105 of the user 100, either over at least partially a cellular network 1714, or over the network(s) 72 (the network(s) transmission represented by the broken line arrow 1715). The electronic map and PoI data which has been transmitted from the store 1710 is stored on a PoI database 1776 (similar to PoI database 76) on a remote server 1778 (similar to server 78).

In FIG. 17A-2, the user 100 enters the store 1710 with the electronic map and PoI data transmitted from the store's computers and computer devices. The user 100 points the smartphone 105 toward a shelf 1780, in which men's sweaters are displayed, in the pointing direction 95. The shelf 1780 is mapped on the electronic map and stored in the PoI database, this information now residing on the smartphone 105. The pointing to PoI 104b, and corresponding smartphone 105 location is correlated to the location of the PoI 104b, where the user 100, receives from the store's remote server 1778 (via the network(s) 72), a message 1782, of “Three Sweaters for $99,” on the smartphone 105.

FIG. 17B is an example of a user 100 receiving PoI data directly approaching a PoI. In this case, each PoI 104 is associated with an electronic device 1795 that sends information to the user device 105 about the PoI itself. For example, consider a user 100 (e.g., a tourist) visiting a museum; the tourist points towards an artwork 1792 (e.g., a painting). At this moment, the user device 105 receives from the electronic device 1795 information 1790 about PoI (e.g., an audio guide device). User can engage the PoI if engaging condition are satisfied and enjoy content associated with the PoI on its device (e.g., audio listening about the paining). The devices 105 and 1795 could be designed (e.g., hardware design as directional antennas, or software design) to exchange information only if some particular conditions are satisfied, for example a maximum distance or a specific orientation between the two devices may be required.

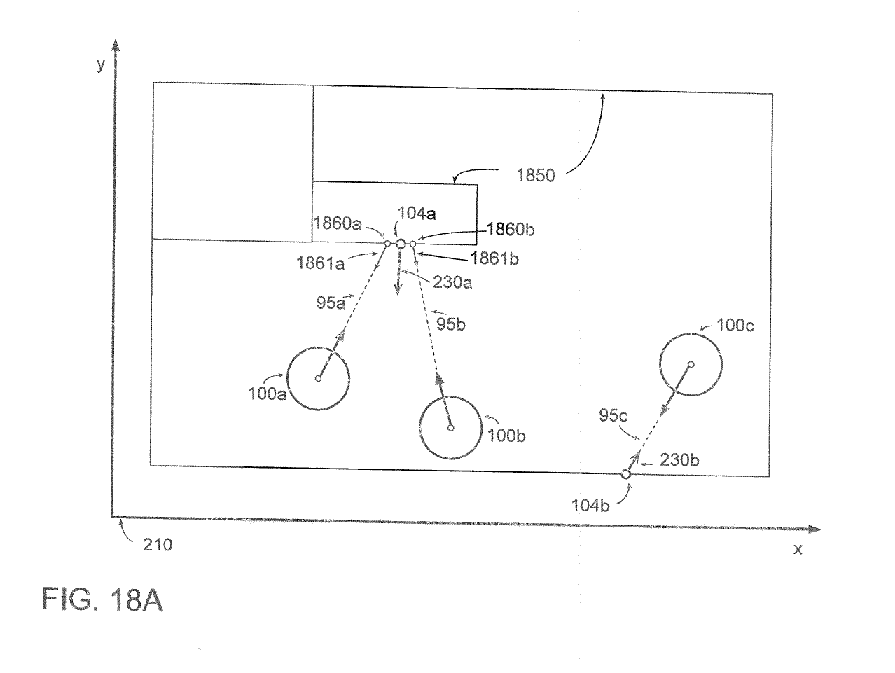

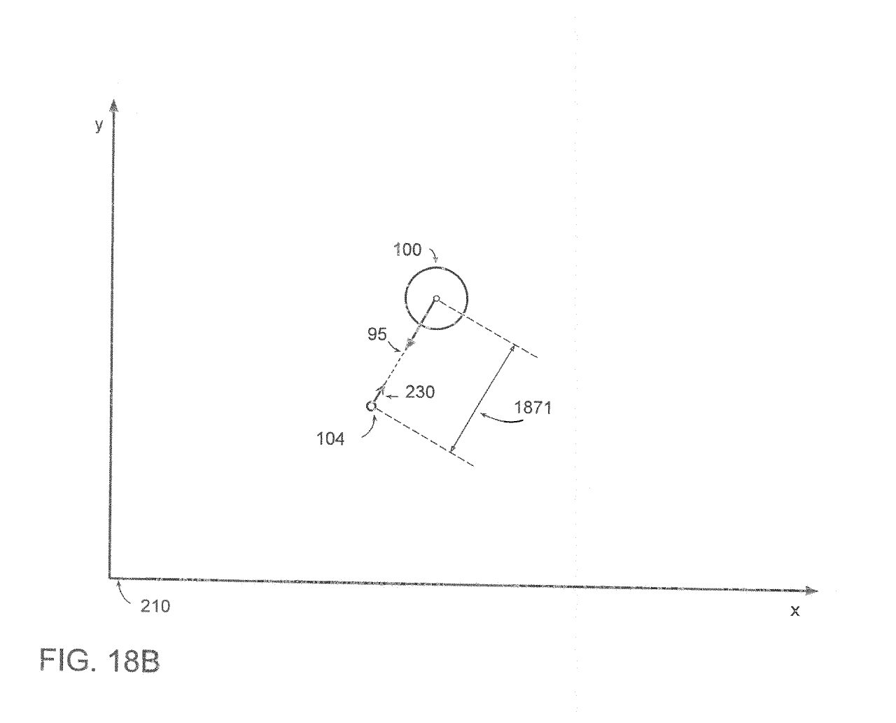

In FIG. 18A are shown examples of creation of new PoIs by localization and pointing leveraging on surrounding map data. User moves to the position 100a and points towards the wall 1850 where he wants to create the new PoI 104a. The system computes the intersections between direction 95 and wall 1850, defining the point 1860a (slightly different respect the desired point, due to user pointing imprecision and sensor accuracy) and the vector 1861a, that has the same direction of the pointing vector 95 and opposite orientation. In order to increase accuracy, the user points again towards the same point on the wall from another position 100b; the system computes a new intersection 1860b between pointing vector 95b and the wall 1850. The user may repeat this operation n-times (e.g., any number of times) to further increase accuracy (not shown). The position of the new PoI 104a is computed as the average position of points 1860a-n, and the orientation 230a is computed as the average between orientations 1861a-n. In the figure, the user 100c creates also the new PoI 104b with a single pointing operation. In analogy with the previous case, the position of PoI 104b is the intersection between vector 95c and the wall 1850, and the orientation is opposite to the pointing vector 95c.

In FIG. 18B, the user creates a new PoI not leveraging on surrounding map data. The user 100 points in the direction 95. The new PoI 104 is created along the direction of the pointing vector 95, at a pre-defined distance 1871 (e.g. 1 meter), with an opposite orientation than pointing vector 95.

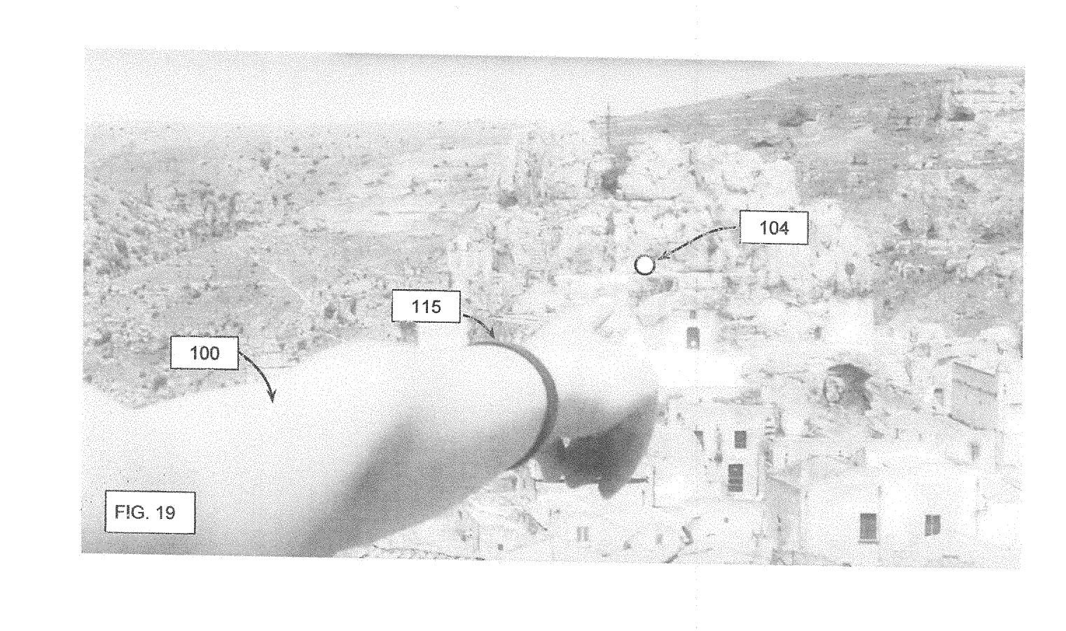

FIG. 19 shows a user 100 wearing a smart band 115 (linked to a smartphone 105) pointing towards a PoI 104, e.g., a historic or cultural site. With the locations of the smart band 115, via the smartphone, and the PoI 104 correlated, the user receives information about the PoI 105, via the smart band 115 or smartphone 105.

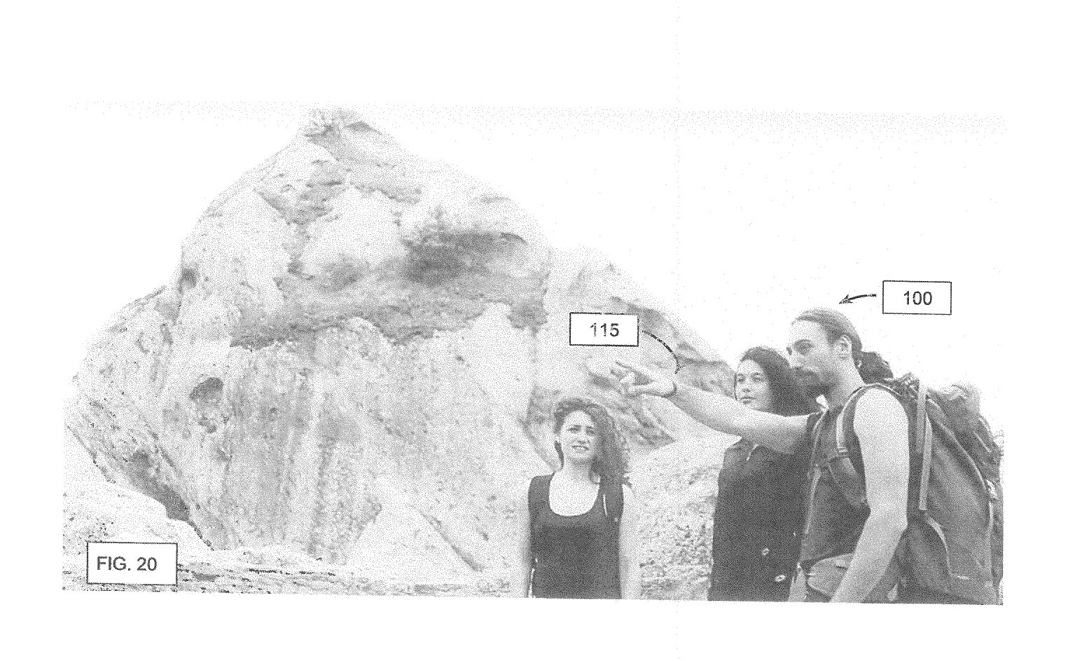

FIG. 20 shows a user 100 wearing a smart band 115 (linked to a smartphone (not shown)) pointing towards a PoI (not shown), e.g., historic or cultural site. With the locations of the smart band 115, via the smartphone, and the PoI 104 correlated, the user 100 receives feedback and other information about the PoI, via the smart band 115 or smartphone 105. For example, the information is from storage media, either internal or external to the smart band/smartphone. External storage media may he in servers, which send the stored information to the smart band 115/smartphone 105, via the network(s) 72.

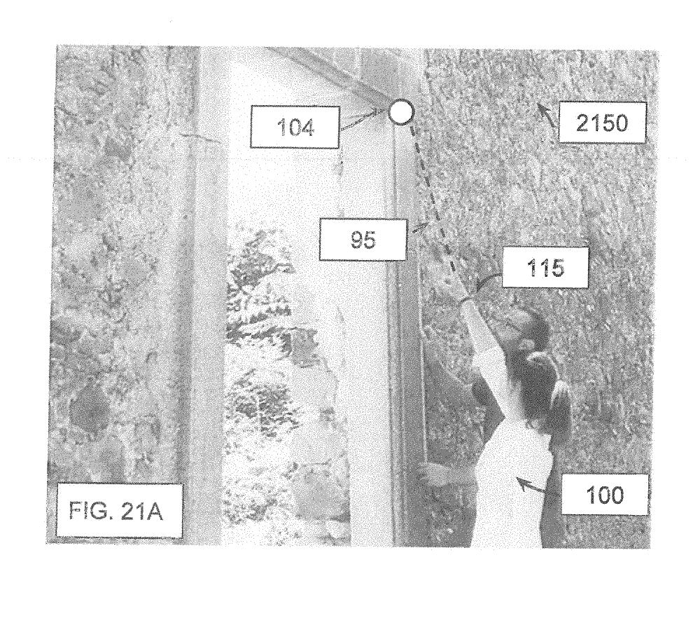

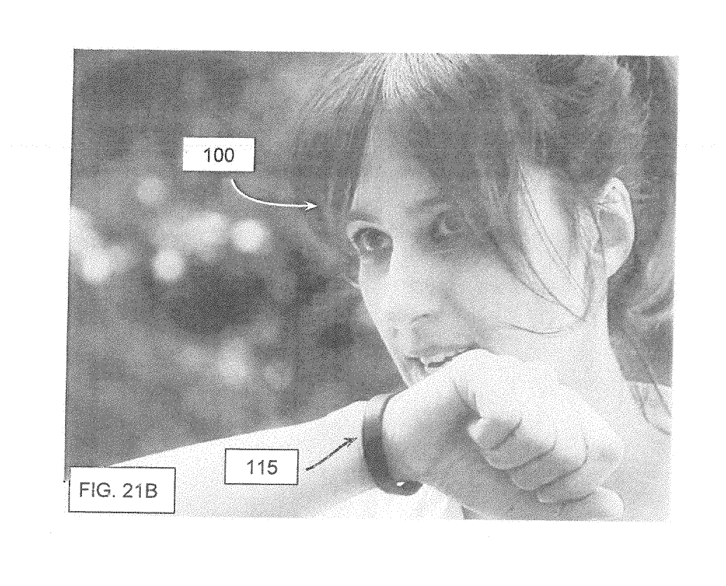

FIG. 21A shows a user 100 with a smart band 115 (linked to a smartphone (not shown)) pointing in the direction 95 of an archway of a wall 2150, so as to create a new PoI 104. The locations of the smart band 115, via the smartphone 105, and the PoI 104 are correlated and electronically mapped in the PoI database (detailed above), which for example, here, resides on the smartphone 105.

FIG. 21B is a picture of the same user 100 of FIG. 21A, adding audio content (e.g., a voice message), via the smart band 115 to the newly created PoI 104. The voice message could also be converted to text using speech-to-text programs and other technology, in order to associate a text content to the PoI, instead of audio content. This data is then entered into the PoI database 76, as described above.

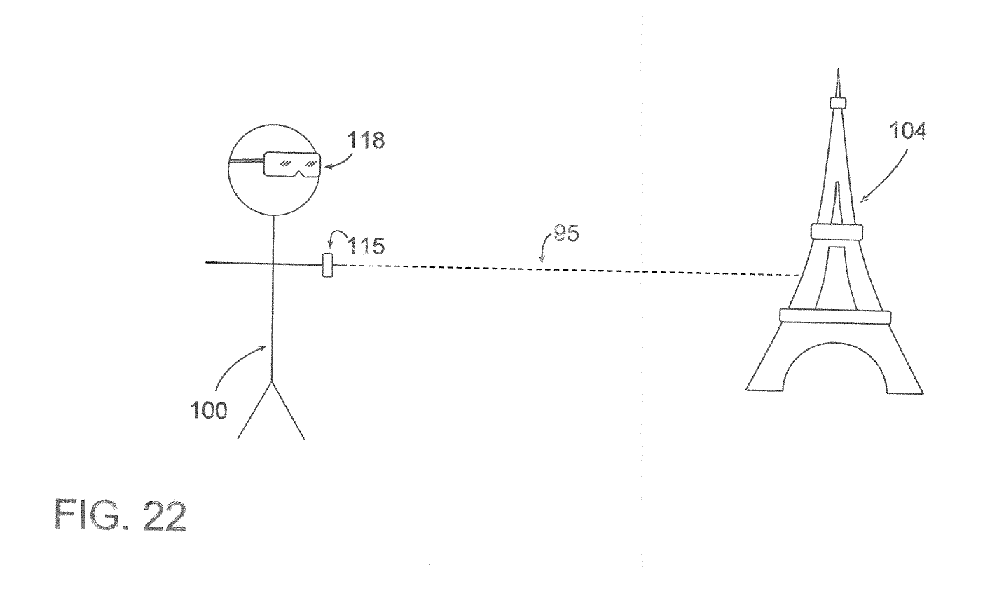

FIG. 22 shows a user 100 wearing a smart band 115 (linked to a augmented reality or virtual reality headset 118) pointing (in the pointing direction 95) towards a PoI 104, such as the Eiffel Tower. With the locations of the smart band 115, via the augmented reality or virtual reality headset 118, and PoI 114 correlated, the user 100 receives feedback and other information about the PoI, via the smart band 115 or headset 118.

There are many other use cases of the present invention in different operational modes, such as in home automation, work places, city environments (smart cities), shopping malls, recreational contexts or educational contexts. In these operational modes described below, the mobile computing devices, which form mobile computing device systems, such as smartphones, smart bands, smart watches and other smart wearables, as well as augmented or virtual reality headsets, alone and when linked, as detailed above, operate in accordance with the descriptions for the embodiments of the invention above.

For example in a home automation situation (also suitable for hotels and similar) the present invention is used to control lights, Hi-Fi, stereo, speaker and sound systems, window shutters, curtains, electric plugs, cookers, and other appliances. This control is via a mobile computing device system, which includes mobile computing devices, such as smartphones, alone and or linked to smart bands, smart watches and other smart wearables, as well as augmented or virtual reality headsets alone, or linked to smartphones, smart bands, smart watches and other smart wearables.

For example, in a home living room, a sofa is mapped as a PoI, with related controlled devices including, for example, a TV, a sound system, and room lights. The user points to the sofa and engages the PoI, for example keeping the pointing device still for at least 3 seconds. Through a command, for example, a voice command “cinema mode”, TV and sound systems are turned on while the lights are dimmed. As another example, entering in the kitchen, cookers and appliances are mapped as PoIs and controlled devices include cookers and appliances. The user points to a cooker and engages it, for example, with a finger snap. Through a command, for example, drawing a circle clock-wise in the air, the cooker is turned on and set to a desired power level. As another example, entering in the bedroom, beds and doors are mapped as PoIs, and curtains, shutters, main room lights, bedside lights and thermostats are the controlled devices. In the evening, the user points to the bed and engages it. Through a command, for example, the user blowing on the wristband (e.g., smart band), shutters and curtains are shut, main lights are turned off, bedroom lights are turned on, and a thermostat is set in a night mode. In the morning, the user points to the door and engages it. Through a command, for example, a finger snap, shutters and curtains are opened and the thermostat is set to a day mode.

In a working environment, the present invention may be used to increase productivity and safety. Controlled devices are, for example, machinery, workstations, emergency call systems, small vehicles, such as drones, or carts. For example, in an inspection and maintenance (I/M) context, an employee enters into a warehouse and all items and goods on the shelves are mapped as PoIs. The controlling device is, for example, the worker's tablet computer.

For example, the employee wants to get information about an item or a good. In this case, the employee (user) points to an item/PoI, and without any further confirmation action, the PoI is engaged. Information about that item is displayed on the worker's tablet computer. Through a command, for example, drawing a “V” in the air, the item is marked as checked.

As another example, a worker wants to instantly shut off machinery, for example, an escalator or a conveyor belt (the equivalent function of a “kill-switch” or “emergency stop button”). The worker enters into the working room and machineries are mapped as a PoI, and the controlled devices are the machineries themselves. In case of an emergency, the worker points to the machinery with a dedicated wristband (e.g., smart band, for example linked to a smartphone) and the machinery is automatically engaged. By clicking a dedicated button on the wristband, the machinery is stopped and shut off.

As another example, in a building site, all workers wear equipment for precise 3D localization. When a worker enters the site, all other workers are mapped as PoIs, and the controlled device is the emergency call system. In case of danger or injury of a worker, a coworker can quickly call for help by pointing his wristband (e.g., smart band, for example linked to a smartphone) to the injured worker and, for example, clicking a dedicated button.

As another example, the worker wants to control a fleet of drones. By entering in the fleet parking area, drones are mapped as PoIs and the controlled devices are the drones themselves. A worker engages a drone/PoI by pointing towards it. If in the pointing direction there are more drones close together, the system may ask to the worker which one he want to control through, for example, a voice command; the worker says for example “drone 12” and engage it. At this point, through a command, for example, another voice command that set the name of a destination, the drone takes off and navigates to the commanded destination.

In an urban or city environment, the present invention is especially useful for tourists and impaired people to obtain information about a neighborhood. For example, an impaired person desires to know opening hours of post offices, banks, drugstores, medical clinics, and other public institutions. Moving through the city, relevant places close to the user are mapped as PoIs, and the controlled device is, for example, a smartphone vibration motor and smartphone speakers. The user moves his smartphone around by himself, and when he accidentally points to a PoI, the PoI is automatically engaged. The system of the invention causes the vibration motor of the smartphone to activate, indicating the presence of a point of interest (PoI) in that direction. Through a command, for example, by shaking the phone, an audio message explains the relevant information for that place, as opening hours and available services.

In another example, a tourist is visiting a city and wants to obtain information about monuments, buildings, churches, and other tourist locations. As in the previous example, moving through the city, relevant places close to tourist sites are mapped as PoIs, and the controlled device is, for example, a smartphone, speakers, or a headset. Here, the tourist wears a smart band. The tourist engages a PoI/tourist spot by pointing at it, for example, with his smartphone on which resides the system of the invention, and performs the confirmation action, for example, turning (rotating) his smartphone on a side (the same gesture as unlocking a door with the key in the lock). An audio guide is automatically triggered, and through gestures, for example, moving the hand up, down, left or right, the tourist can control volume, skip part of the audio guide, or listen again to some part of it.

As another example, the present invention is used to obtain real-time information about the public transportation in a city. In this case, the PoIs are bus poles and buses, and the controlled devices are, for example, the user's smartphone. Moving through the city, bus poles and buses nearby are mapped as PoI. Pointing the smartphone to one of these PoI and performing the confirmation action (for example, tapping on the smartphone screen), user can get information about waiting times (for bus poles) or bus route (for buses). Through a command, for example another tap on a button on the screen, the user can buy a ticket for that bus.

In a shopping mall, the present invention is used to get information about a product, or find a desired shop. The case of getting information about a product in a shop is similar to the case of a worker getting information about an item in a warehouse, described above. The case of finding a favorite shop is similar to the case of an impaired people looking for information about relevant places in the neighborhood, described above.

In a recreational operations, the present invention could be used to improve the user experience and could enable new kind of entertainment. For example, in a museum, the present invention could be considered as an evolution of the audio guide. As an example of user experience, at the ticket desk of a museum, the visitor could download a dedicated application on his smartphone and rent a dedicated smart band and a pair of headphones. As another example, the visitor could rent a dedicated audio guide device for both pointing and listening. When the visitor enters a room of the museum, artworks in the room, for example, paintings and sculptures, are mapped as PoIs. When the user points to a work with his wrist-band, and performs the confirmation action, for example, by twisting the smart-band or the audio guide device, the audio guide for the pointed work is played. Through a command, for example, waving the hand in front of the smartphone using for example the infrared proximity sensor to detect the movement), the user can skip part of the guide, with another command, for example waving twice in front of the smartphone, the user can rewind the audio guide. With another gesture, for example, holding the hand in front of the smartphone, the user can stop the audio guide. Other locations similar to the museum are: national parks, where the PoIs could be mountain peaks, gorges, relevant trees and other natural spots; cultural heritage and archaeological sites or botanic gardens, where PoIs could be any relevant object or spot.

As another example, the present invention is used in an exhibition of contemporary art for innovative interactive works. As an example, the user enters in the exhibition hall, and all the works in the hall are mapped as PoIs. The visitor points the smartphone to a work and engages it. A confirmation action is different for each work and related to the work itself, for example, a kiss (recognized through the smartphone microphone) to engage a picture of lips. When the work is engaged, the visitor can interact with it through commands, different for each work. As an example, smartphone movements could be mapped to the movement of a robotic puppet.

As another example, the present invention is used for educational purposes. For example, it is used to teach astronomy, by teaching stars and constellations names and positions. In this example, stars in the visible sky at the current location of the user are mapped as PoIs. The controlled device could be a motorized device with a laser for star pointing. When the user points to a star, with his mobile computing device, e.g., smart band, for example linked to a smartphone, the laser also points to the pointed star. Alternatively, the controlled device could be a smartphone or tablet screen. When the user points to a star, information about that star is displayed on the device screen. If more than one star is in the pointing direction, the system through the selection system may automatically select the most relevant (e.g. the brightest); alternatively, system may prompt the user for selection, though, for example, tilting or flipping the smartphone.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, non-transitory storage media such as a magnetic hard-disk and/or removable media, for storing instructions and/or data. Optionally, a network connection is provided as well. A display and/or a user input device such as a keyboard or mouse are optionally provided as well.

For example, any combination of one or more non-transitory computer readable (storage) medium(s) may be utilized in accordance with the above-listed embodiments of the present invention. The non-transitory computer readable (storage) medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

As will be understood with reference to the paragraphs and the referenced drawings, provided above, various embodiments of computer-implemented methods are provided herein, some of which can be performed by various embodiments of apparatuses and systems described herein and some of which can be performed according to instructions stored in non-transitory computer-readable storage media described herein. Still, some embodiments of computer-implemented methods provided herein can be performed by other apparatuses or systems and can be performed according to instructions stored in computer-readable storage media other than that described herein, as will become apparent to those having skill in the art with reference to the embodiments described herein. Any reference to systems and computer-readable storage media with respect to the following computer-implemented methods is provided for explanatory purposes, and is not intended to limit any of such systems and any of such non-transitory computer-readable storage media with regard to embodiments of computer-implemented methods described above. Likewise, any reference to the following computer-implemented methods with respect to systems and computer-readable storage media is provided for explanatory purposes, and is not intended to limit any of such computer-implemented methods disclosed herein.

The flowcharts and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

As used herein, the singular form “a”, “an” and “the” include plural references unless the context clearly dictates otherwise.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

The above-described processes including portions thereof can be performed by software, hardware and combinations thereof. These processes and portions thereof can be performed by computers, computer-type devices, workstations, processors, micro-processors, other electronic searching tools and memory and other non-transitory storage-type devices associated therewith. The processes and portions thereof can also be embodied in programmable non-transitory storage media, for example, compact discs (CDs) or other discs including magnetic, optical, etc., readable by a machine or the like, or other computer usable storage media, including magnetic, optical, or semiconductor storage, or other source of electronic signals.

The processes (methods) and systems, including components thereof, herein have been described with exemplary reference to specific hardware and software. The processes (methods) have been described as exemplary, whereby specific steps and their order can be omitted and/or changed by persons of ordinary skill in the art to reduce these embodiments to practice without undue experimentation. The processes (methods) and systems have been described in a manner sufficient to enable persons of ordinary skill in the art to readily adapt other hardware and software as may be needed to reduce any of the embodiments to practice without undue experimentation and using conventional techniques.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

1-44. (canceled)

45. A method for providing mobile computing device system interactions comprising:
populating an electronic map with at least one point of interest;
receiving 1) location data, and 2) pointing data corresponding to the at least one point of interest, from the mobile computing device system;
for the location corresponding to the received location data, correlating the location associated with the received pointing data with the location and orientation of the at least one point of interest; and,
causing an action to be taken associated with the at least one point of interest.

46. The method of claim 45, wherein the populated electronic map is stored in storage media.

47. The method of claim 45, wherein the action to be taken includes controlling an electronic device, by the mobile computing device system.

48. The method of claim 45, wherein the action to be taken includes obtaining data for the mobile computing device system.

49. The method of claim 45, wherein the mobile computing device system includes a smartphone.

50. The method of claim 45, wherein the mobile computing device system includes a smartphone in communication with at least one of a wearable or sub-dermal computing device, and the pointing data is obtained from the wearable or sub-dermal computing device.

51. The method of claim 45, performed by at least one processor of a computer system.

52. The method of claim 51, wherein the computer system resides on at least one of:
a) a server linked to a network, and the mobile computing device system is linked to the network;
b) the mobile computing device system; or,
c) both of a server and the mobile computing device system, and, the server and the mobile computing device system are linked to each other by a network.

53. The method of claim 45, wherein populating the electronic map includes at least one of:
a) 1) designating a location for the map;
2) providing the map with electronic coordinates; and,
3) inputting at least one point of interest to the map, the at least one point of interest including electronic coordinates within the map; or,
b) 1) obtaining an electronic map with electronic coordinates associated with a location; and,
2) inputting the at least one point of interest to the map, by converting pointing data received from the mobile computing device system to coordinates on the map.

54. The method of claim 53, wherein the inputting at least one point of interest includes converting pointing data received from the mobile computing device system to coordinates on the map.

55. The method of claim 45, wherein the correlating includes determining that the location associated with the received pointing data and the location of the at least one point of interest, are within a predetermined distance from each other.

56. A method for operating a mobile computing device system comprising:
associating location data of the mobile computing device system with an electronic map, the electronic map including at least one point of interest; and,
signaling the mobile computing device system when the pointing direction of the mobile computing system correlates with the at least one point of interest.

57. The method of claim 56, wherein the signaling is such that the mobile computing system provides at least one of a visual, tactile or audio indication upon the correlation of the mobile computing system with the at least one point of interest.

58. The method of claim 56, wherein the mobile computing system includes at least one of:
a pointing device and a signaling device; or,
a mobile computing device.

59. The method of claim 58, wherein the pointing device and the signaling device are selected from the group consisting of smart phones, smart bands, smart watches, sub-dermal microchip implant, augmented and virtual reality headsets.

60. A computerized system for facilitating mobile computing device system interactions comprising:
a mapping system for creating electronic maps of at least one point of interest;
a pointing system for determining whether a mobile computing device of the mobile computing device system is directed to the at least one point of interest;
a localization system for determining the location associated with the mobile computing device; and
an engagement system for engaging the mobile computing device system with the at least one point of interest, the engaging causing the mobile computing device system to perform an action associated with the at least one point of interest.

61. The computerized system of claim 60, wherein the action associated with the at least one point of interest includes receiving, by the mobile computing device system, at least one of feedback associated with the at least one point of interest, and data corresponding to information associated with the at least one point of interest.

62. The computerized system of claim 60, wherein the engagement system is configured for determining a correlation between the location of the mobile computing device and the location of the at least one point of interest based on a predetermined distance between the locations.

63. The computerized system of claim 60, additionally comprising a point of interest database linked to the mapping system.

64. The computerized system of claim 63, additionally comprising one or more of:
a control system for controlling at least one electronic device associated with the at least one point of interest;
a selection system for selecting one point of interest when the at least one point of interest includes at least two points of interest; and,
a network communication system for facilitating communications between the computerized system and components over a network.

65. The computerized system of claim 60, residing on a mobile computing device system.

66. The computerized system of claim 65, wherein the mobile computing device system includes at least one of:
a) a smartphone and an augmented or virtual reality headset; or,
b) a smartphone or augmented or virtual reality headset in communication with a wearable or sub-dermal computing device.

67. A computer-usable non-transitory storage medium having a computer program embodied thereon for causing a suitable programmed system to facilitate mobile computing device system interactions, by performing the following steps when such program is executed on the system, the steps comprising:
receiving an electronic map of a predetermined location populated with at least one point of interest within the predetermined location;
receiving: 1) location data of the predetermined location; and, 2) pointing data corresponding to the at least one point of interest within the predetermined location, from the mobile computing device system;
for the predetermined location corresponding to the received location data, correlating the location associated with the received pointing data with the location of the at least one point of interest; and,
causing an action to be taken associated with the at least one point of interest.

68. A method for controlling electronic devices, comprising:
locating a controlling device in an electronically mapped space;
responding to the locating of the controlling device by placing the controlling device in the electronically mapped space in electronic communication with the electronic device to be controlled; and,
performing an action associated with the controlling device to control the electronic device.

69. The method of claim 68, wherein the mapped space is based on at least one of:
a static electronic map; or,
a dynamically created electronic map.
